(19) United States
(12) Patent Application Publication
(10) Pub. No.: US 2012/0126756 A1
(43) Pub. Date: May 24, 2012

(54) Charge-driven electrostatic inductance

(76) Inventor: John M. Vranish, Crofton, MD (US)

(21) Appl. No.: 13/317,273

(22) Filed: Oct. 13, 2011

Related U.S. Application Data
(60) Provisional application No. 61/458,238, filed on Nov. 19, 2010.

(51) Int. Cl. H02J 7/00

(52) U.S. Cl. 320/166

(57) ABSTRACT

Charge-Driven Electrostatic Induction is a method for using modest voltage to induce large density electric charge across a large insulation gap. Large density equal and opposite charges are first created in a high performance capacitor adjacent said insulation gap. One charge is trapped on its electrode and the other charge is relocated further from the gap so the electric field from the trapped charge, with minimum interference, induces equal and opposite charge across the gap and stores large density electric energy in the insulation. With electrode area to gap ratio kept sufficiently large to limit field fringing, Charge-Driven Electrostatic Induction will rival electromagnetic motor performance. In practice it will be superior. Using layered, thin film components will eliminate permanent magnets, coils, ferromagnetic materials and large power current sources. The multi-step process will permit high operating speeds.

### CROSS REFERENCE TO RELATED APPLICATION

The U.S. patent application claims the priority of U.S. Provisional Application No. 61/458,238 filed on Nov. 19, 2010.

The invention is related to an invention shown and described in Provisional Patent, U.S. Ser. No. 61/458,238 entitled “Charge-Driven Electrostatic Induction”, filed in the name of John M. Vranish, the present inventor on Nov. 19, 2010. The above are assigned to the assignee of the present invention. The teachings of this related application is, herein meant to be incorporated by reference. The invention is also related to an invention shown in: Vranish, J. M., Device, System and Method for a Sensing Electric Circuit, U.S. Pat. No. 7,622,907, Nov. 24, 2009. [“Driven Ground”] the rights to which are held by the US Government.

### ORIGIN OF THE INVENTION

The invention was made by John M. Vranish as President of Vranish Innovative Technologies LLC and may be used John M. Vranish and Vranish Innovative Technologies LLC without the payment of any royalties therein or therefore.

### BACKGROUND OF THE INVENTION

The Charge-Driven Electrostatic Induction concept began with a need to actuate flexures in a Tape Motor invention. Permanent magnet electromagnetic drives were too large and cumbersome. Electrostatic drives were too weak and required voltages that were too high. John M. Vranish looked to electrets as an alternative to permanent magnets. But, it soon became apparent that devices that behave like electrets could be produced by trapping and isolating electric charge on capacitor electrodes. In the process of investigating alternatives to electrets, it soon became apparent that new capacitive materials enabled exceptional charge density from modest voltage. But, there were still problems in isolating the charge and in directing the electric flux from the charge. Step by step, the Charge-Driven electrostatic concept began to evolve to this point. It will continue to evolve.

### FIELD OF THE INVENTION

The invention relates generally to Electrostatic Induction and more particularly to working level voltage, electrostatic applications. The invention relates generally to electret applications as an alternative method. The invention relates generally to electromagnetic induction as an electrostatic alternative for electromagnetic induction applications. The invention relates generally to high voltage applications as a working level voltage alternative and more particularly to step up and step down voltage transformers. The invention relates particularly to electrostatic power generation devices, power transfer devices, motor devices and sensors, both static and quasi-static.

### DESCRIPTION OF THE PRIOR ART

Electrostatic Motors, Micromotors, Piezoelectric Travelling Wave Motors and Piezoelectric Inch Worms have, traditionally, performed precision positioning. Charge-Driven Electrostatic Induction, in combination with bending flexures, is presented as an alternative with advantages. (Bending Flexures is presented separately from this patent application.)

Electric Motors, using electromagnetism, constitutes a body of prior art. Charge-Driven Electrostatic Induction introduces an electrostatic alternative with advantages.

Electromagnetic Generators also constitute a body of prior art. Charge-Driven Electrostatic Induction introduces an electrostatic alternative with advantages.

Electret Microphones use elements with permanent polarization to perform functions of converting mechanical oscillating motion to electrical energy and output voltage. Charge-Driven Electrostatic Induction performs the same function without using permanently polarized elements and with the advantage of being able to easily neutralize stray charge. This argument can be extended to energy harvesting and scavenging devices and methods.

Transformers use coils and electromagnetism to step up or step down voltage as per traditional prior art. Charge-Driven Electrostatic Induction presents an alternative with advantages using multiple stacked capacitors rather than multiple coils.

Electromagnetic means, analogous to Electromagnetic Motors, has been used to transfer electric power across a joint with an air or vacuum gap between the moving members. Charge-Driven Electrostatic Induction performs the same function with advantages using electrostatics.

### SUMMARY OF THE INVENTION

Charge-Driven Electrostatic Induction is a method for using modest voltage to induce large density electric charge across a large insulation gap. Large density equal and opposite charges are first created in a high performance capacitor adjacent said gap. One charge is removed and the electric field of the remaining charge is reflected into the gap where it induces equal and opposite charge on the far side and stores large density electric energy in said gap as per Gauss' Law of Charges and the method of images. With electrode area to gap ratio kept sufficiently large to limit field fringing, Charge-Driven Electrostatic Induction can rival electromagnetic motor performance. In practice, it will be superior. Constructed of layered, thin film components, Charge-Driven Inductance devices will be lighter, more compact and less expensive than their permanent magnet, electromagnetic counter parts. Coils, winding process, ferromagnetic materials, rare earth permanent magnets and large current power sources will be unnecessary and integration of controls and action devices will be more seamless. The multi-step process will permit high operating speeds. The principles behind Charge-Driven Electrostatic Induction are explained and construction of a device using Charge-Driven Electrostatic Induction is illustrated. Applications are presented illustrating use as an electrostatic motor, an electrostatic generator, and an electrostatic device for transferring power across a large air or vacuum gap. Performance enhancing techniques of Electric Field Projection and Charge Compression are introduced.

### BRIEF DESCRIPTION OF THE DRAWINGS

A more complete appreciation of the invention and many of its attendant advantages will be readily appreciated as the same becomes better understood by reference to the following detailed description when considered in connection with the accompanying drawings wherein:

FIG. 1 illustrates the major components of a basic Charge-Driven Electrostatic Induction Device and how they are arranged with respect to each other.

FIG. 2a illustrates how equal and opposite charges are created in close proximity to each other and how one of the charges is trapped in place on its electrode.

FIG. 2b illustrates how the second of the charges is displaced from the trapped charge to provide separation and isolation for said trapped first charge.

FIG. 2c illustrates how the separated equal and opposite charges are trapped in place when the voltage source removed.

FIG. 3a. illustrates the charge arrangement before the grounded conductor is introduced.

FIG. 3b. illustrates the charge arrangement after a grounded conductor is introduced nearby and shows energy stored in the insulation gap between the stack of electrodes and the grounded conductor.

FIG. 4a. illustrates the effects of a nearby grounded conductor on initial charge formation and initial charge arrangement after a first charge is trapped.

FIG. 4b. illustrates the effects of a nearby grounded conductor on charge formation and charge arrangement when a second step in charge formation and charge trapping is performed.

FIG. 5a shows the floating outer electrode case.

FIG. 5b shows the grounded outer electrode case.

FIG. 6 illustrates the effects of simultaneously charging a first one third of the electrodes in a stack of capacitors.

FIG. 7 illustrates the effects of simultaneously charging a second one third of the electrodes.

FIG. 8 illustrates the effects of simultaneously charging the remaining one third of the electrodes.

FIG. 9 illustrates the energy stored in the charged stack of electrodes.

FIG. 10a illustrates the electric field and charge configuration when electric field is applied in a motor application, where the moving member moves transverse to the electric field.

FIG. 10b illustrates residual effects when the electric field is removed.

FIG. 11a illustrates charge distribution and electric field configuration in a motor application in which the moving member moves along the direction of the field, after the field is applied, but before the moving member has moved.

FIG. 11b illustrates the charge distribution and electric field configuration after limited movement has occurred.

FIG. 12a shows the effects of applying an electric field in a power transfer application across an air/vacuum gap typical of moving joints of machines, motors and generators.

FIG. 12b shows the effects when the electric field is removed.

FIG. 13a illustrates a first position in an apparatus that converts time varying mechanical energy to electrical energy.

FIG. 13b illustrates a second position. A comparison of the two positions and the effect on the electric energy stored in the apparatus insulation gap provides insight into the charge-driven electrostatic energy conversion process.

FIG. 14 illustrates the electrical ground termination apparatus for receiving the generated electrical power illustrated in FIG. 13a and FIG. 13b and for making it available for external use.

FIG. 15a illustrates a first position in an apparatus that uses passive electronic components in converting time varying mechanical energy to electrical energy.

FIG. 15b illustrates a second position. A comparison of the two positions and the effect on the electric energy stored in the apparatus insulation gap provides insight into the charge-driven electrostatic energy conversion process using passive electronic components.

FIG. 16 illustrates an electrical ground termination and electrical energy storage system for receiving and storing the generated electrical power illustrated in FIGS. 14a and 14b where passive electronic components.

### DETAILED DESCRIPTION OF THE PREFERRED EMBODIMENT

### A. Description

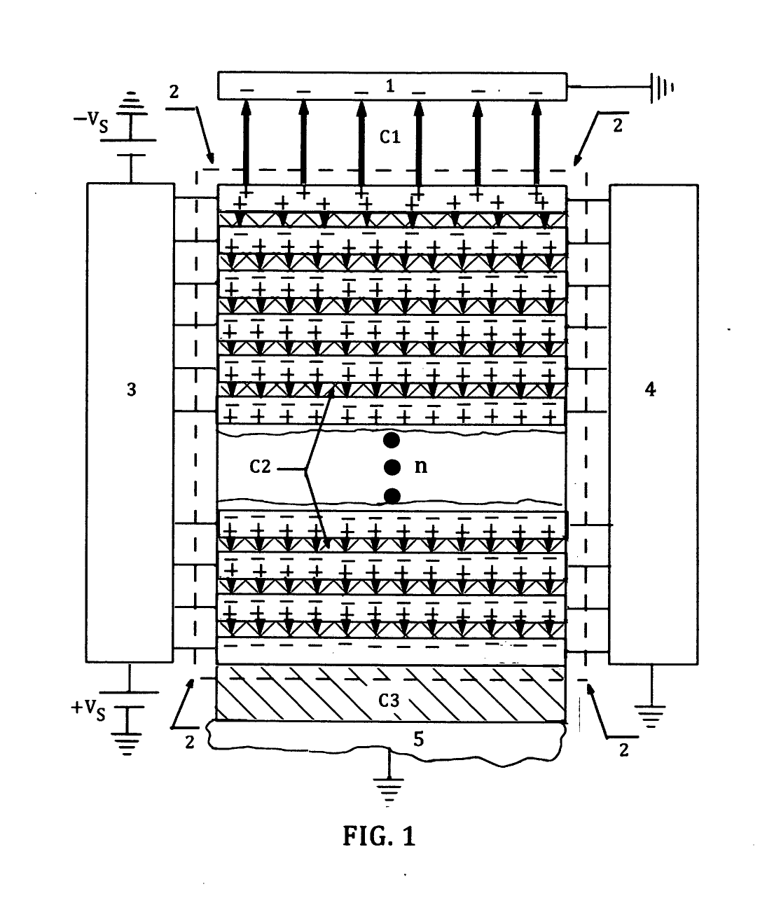

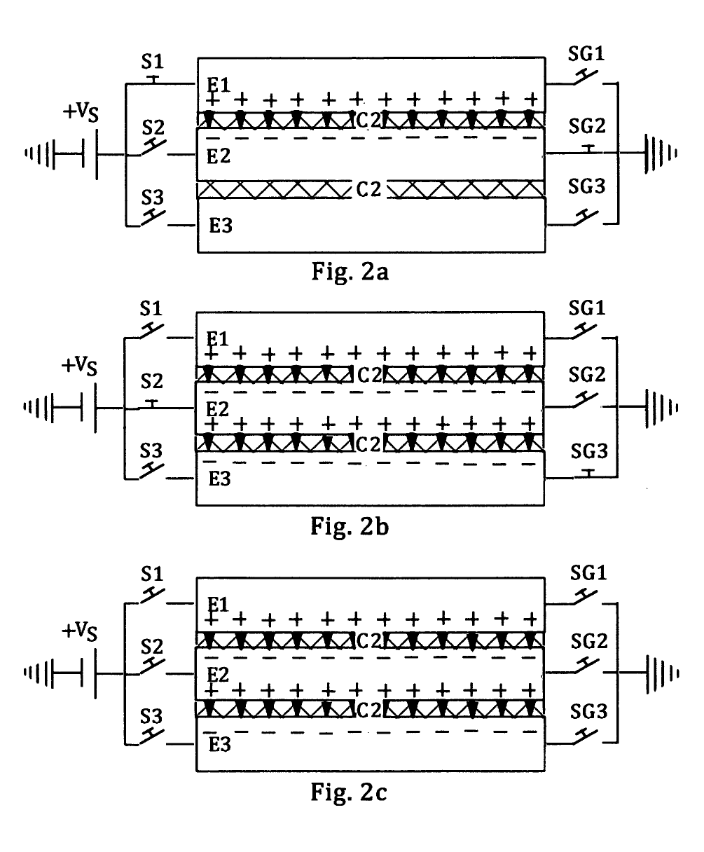

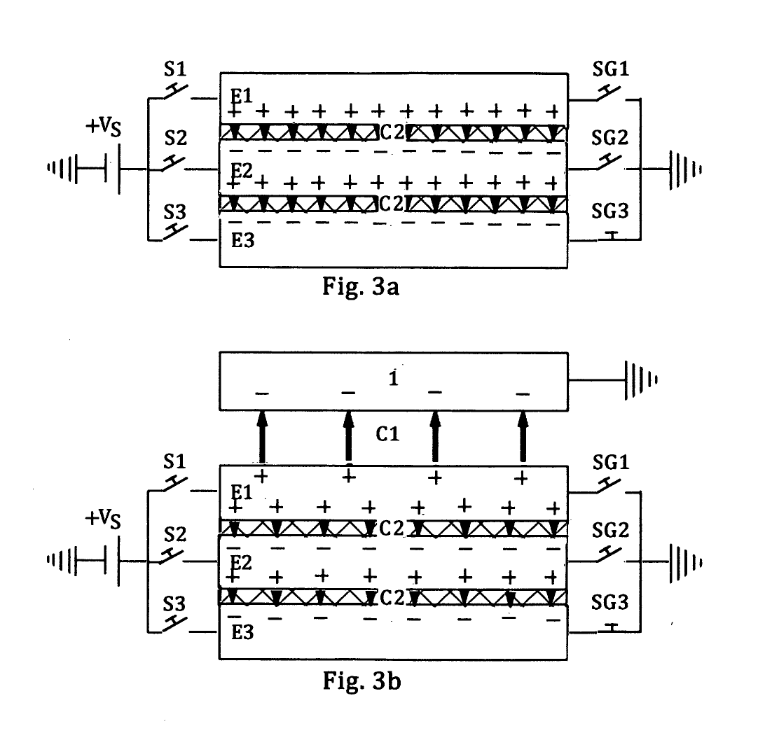

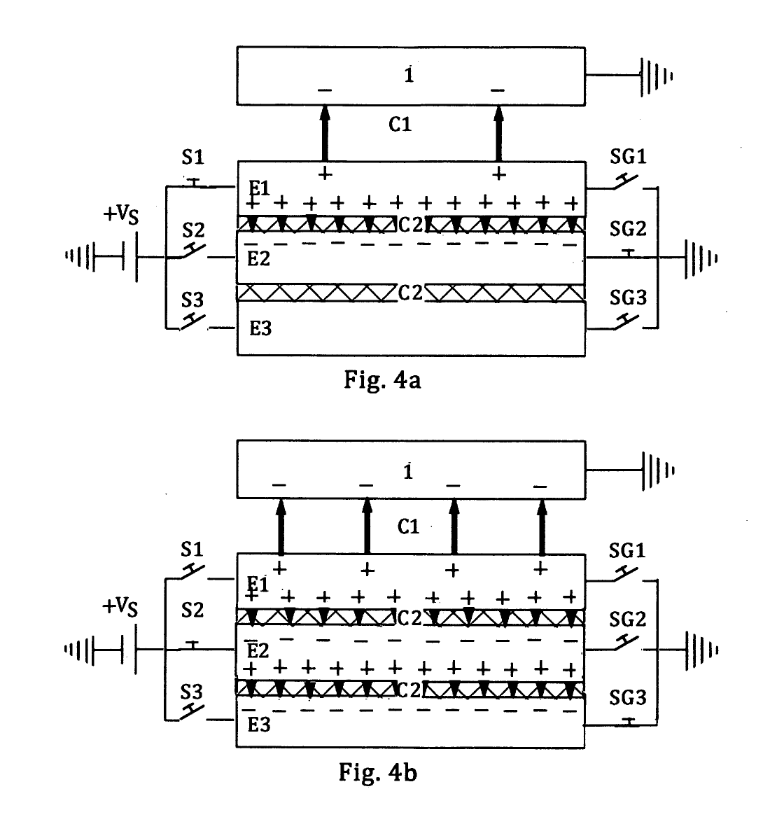

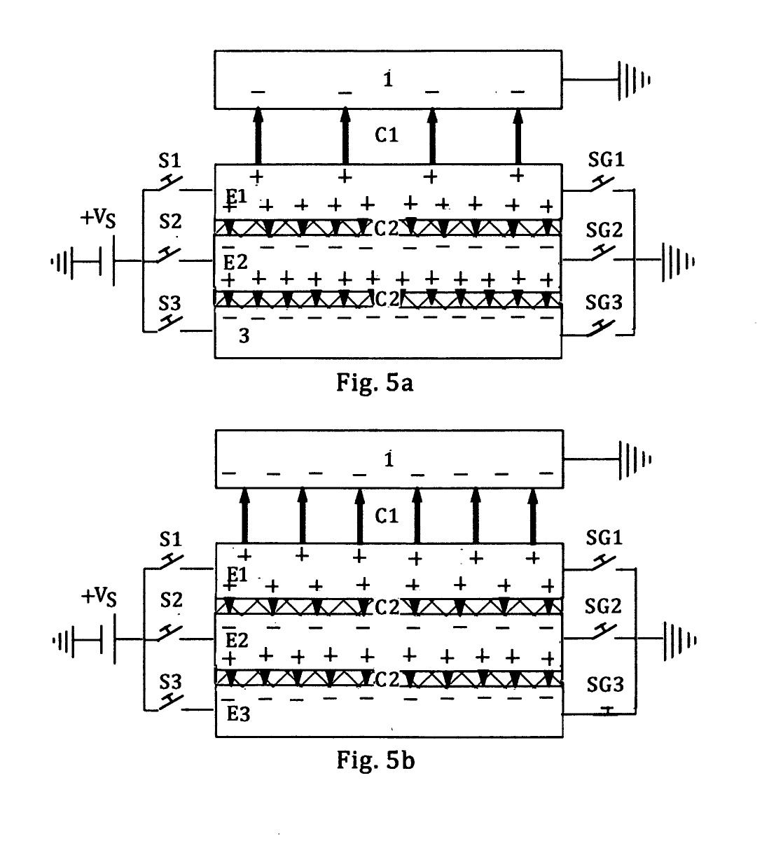

In accordance with the present invention, A Charge-Driven Electrostatic Induction System a Charge-Driven Electrostatic Induction System includes a 1). A Charge Creation and Isolation Capacitor System, 2). An Air or Vacuum Gap adjacent to said Charge Creation and Isolation Capacitor, with Remote Electrical Conductor on the Far Side of the Gap, 3). A Housing. The preferred embodiment of A Charge-Driven Electrostatic Induction System is configured according to FIG. 1, with said Charge Creation and Isolation System comprising a stack of parallel electrodes each separated from its neighbors by an ultra-thin, high dielectric constant film. The electrodes are charged in parallel but, the stack of electrodes performs like a set of charged capacitors connected in series. As such, the voltage of each of the individual charged capacitors adds to provide a very high stack voltage capable of performing significant electrostatic induction across large insulation gaps. A novel trapped charge step method enables energy to be stored in a stack of capacitors such that the voltages add in series. This method of storing energy is illustrated in FIGS. 2a, 2b and 2c. The internal adjustments made in said stored energy under the influence of a nearby grounded conductor is shown in FIGS. 3a, 3b, 4a and 4b. Effects of grounding or floating the electrode in the stack furthest from said nearby grounded conductor are illustrated in FIGS. 5a and 5b.

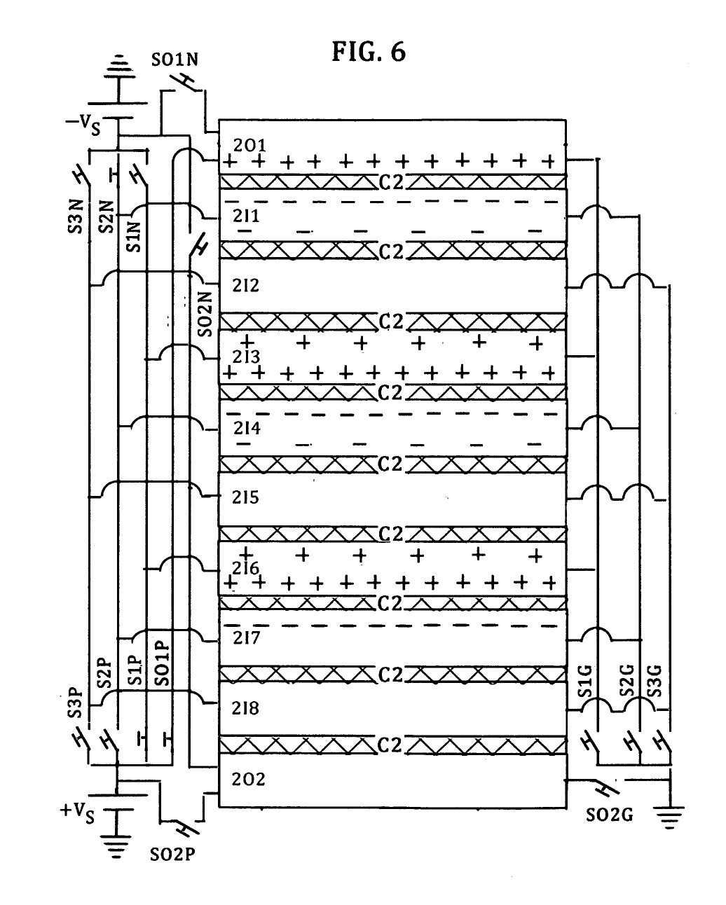

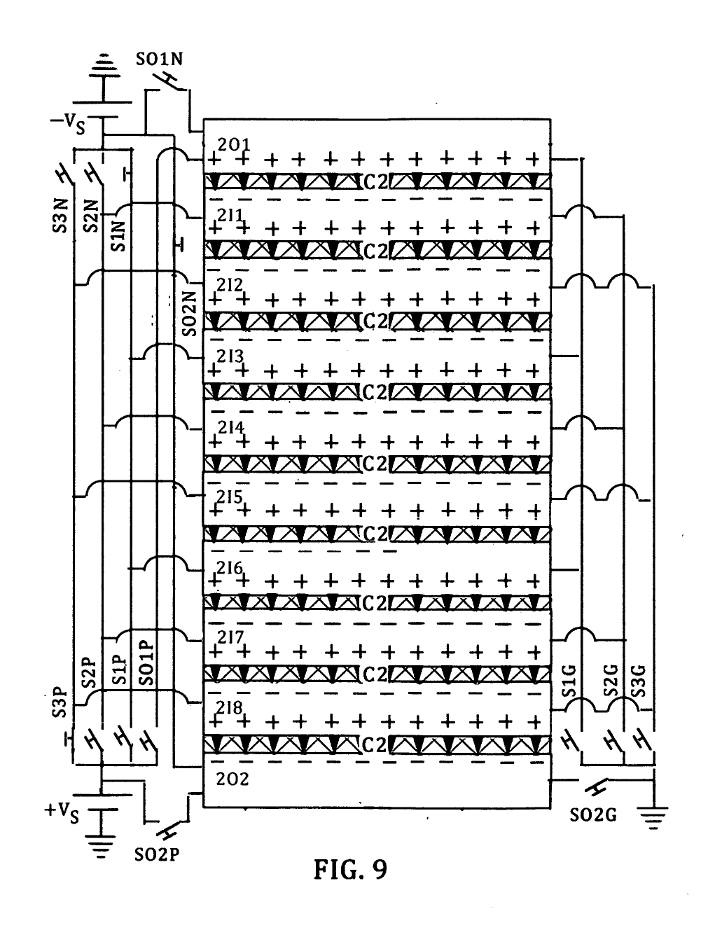

Current technology permits stacks with electrodes and dielectric films in the hundreds so a method for rapidly charging said electrodes is presented, whereby multiple electrodes can be charged or discharged simultaneously. This method is illustrated in FIGS. 6, 7, 8 and the resulting stored energy distribution in the stack is illustrated in FIG. 9.

The invention will now be described in more detail by way of example with reference to the embodiments shown in the accompanying figures. It should be kept in mind that the following described embodiments are only presented by way of example and should not be construed as necessarily limiting the inventive concept to any particular physical configuration.

### B. Construction

The construction of a Charge-Driven Electrostatic Induction System according to FIG. 1 will now be described.

1). Charge Creation and Isolation System. Said Charge Creation and Isolation System, (according to FIGS. 6, 7 and 8) comprising a stack of parallel electrode capacitors wherein a first outer electrode, labeled 2O1 is followed by an ultra-thin, high dielectric constant film, labeled C2, followed in turn by n Inner Electrodes, labeled 2I1, 2I2, 2I3, . . . 2In, each separated from another by an ultra-thin, high dielectric constant film labeled C2 terminating in second outer electrode, labeled 2O2. The second outer electrode 2O2 is separated from the n'th inner electrode by an ultra-thin, high dielectric constant film, labeled C2, on one surface and by a second insulating film on its other surface, labeled C3. C3, in turn, connects said stack of electrodes to Support Structure, labeled 3. Film C3, need be an electrical insulator but, it need not be thin nor have a high dielectric constant.

2). Switch System. Said Switch System comprising a voltage source, a system of electrically conducting wires whereby said voltage source is connected to each of the electrodes described in 1). Charge Creation and Isolation System and a set of computer controlled switches (according to FIGS. 1, 6, 7 and 8) whereby each said voltage source and electrode connection can be opened or closed on command. Said Switch System also comprising a system of electrically conducting wires whereby each said electrode is connected to an electrical ground and a set of computer controlled switches whereby each said electrode and ground connection can be opened or closed on command. Said Switching System component (labeled 3) that connects and disconnects said electrodes and said voltage sources is separate and distinct from said Switching System component (labeled 4) that connects and disconnects said electrodes and said electrical ground. Said electrodes are each served by both Switching System components.

The switches in 3 service all n+2 electrodes. Each inner electrode in said stack of electrodes (labeled 2) has one switch that connects it to and disconnects it from +V_{S} (labeled S1P, S2P, S3P, etc.) and has one switch that connects it to and disconnects it from −V_{S} (labeled S1N, S2n, S3N, etc.). The outer electrodes are each, independently, serviced by two switches, with one switch (labeled SO1P) and one switch (labeled SO1N) connecting and disconnecting said first outer electrode (labeled 201) to and from +V_{S} and −V_{S} respectively and one switch (labeled SO2P) and another switch (labeled SO2N) connecting and disconnecting said second outer electrode (labeled 202) to and from +V_{S} and −V_{S} respectively. Said electrodes can be connected in groups so that a group of electrodes can be simultaneously serviced by a single switch. In this arrangement, S1P, S1N, S2P, S2N etc, connect groups of electrodes, hard wired together.

The switches in 4 service all n+2 electrodes. Each inner electrode in said stack of electrodes (labeled 2) has one switch that connects it to and disconnects it from ground (labeled S1G, S2G, S3G, etc.). The second outer electrode (202) has a dedicated switch to and from ground (labeled SO2G). A first outer electrode (201) will also require a dedicated switch (labeled SO1G) to and from ground except when the said electrodes are grouped. With grouped electrodes, S1G eliminates the need for SO1G.

3). Target Conductor. Said Target Conductor, labeled 1 in FIG. 1, is separated from said stack of parallel electrode capacitors by insulation gap C1. Said Target Conductor is electrically grounded to said Support Structure ground.

4). Support Structure. Said Support Structure (labeled 5), houses and fixes the components of the Charge-Driven Electrostatic Induction System. It also provides the common electrical ground for all components therein.

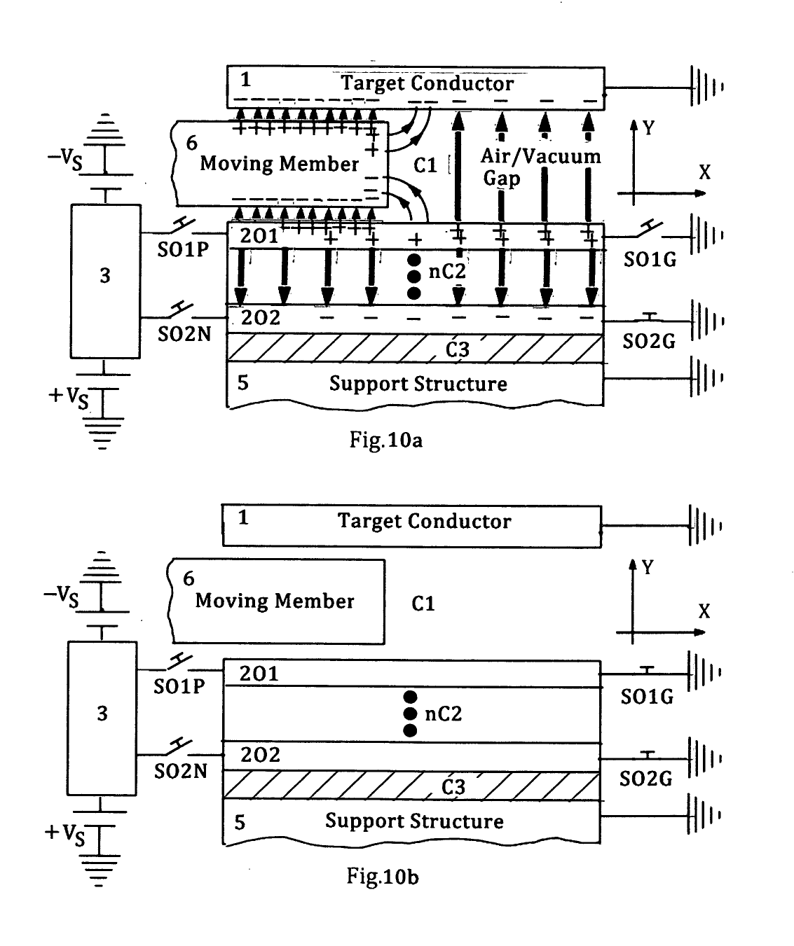

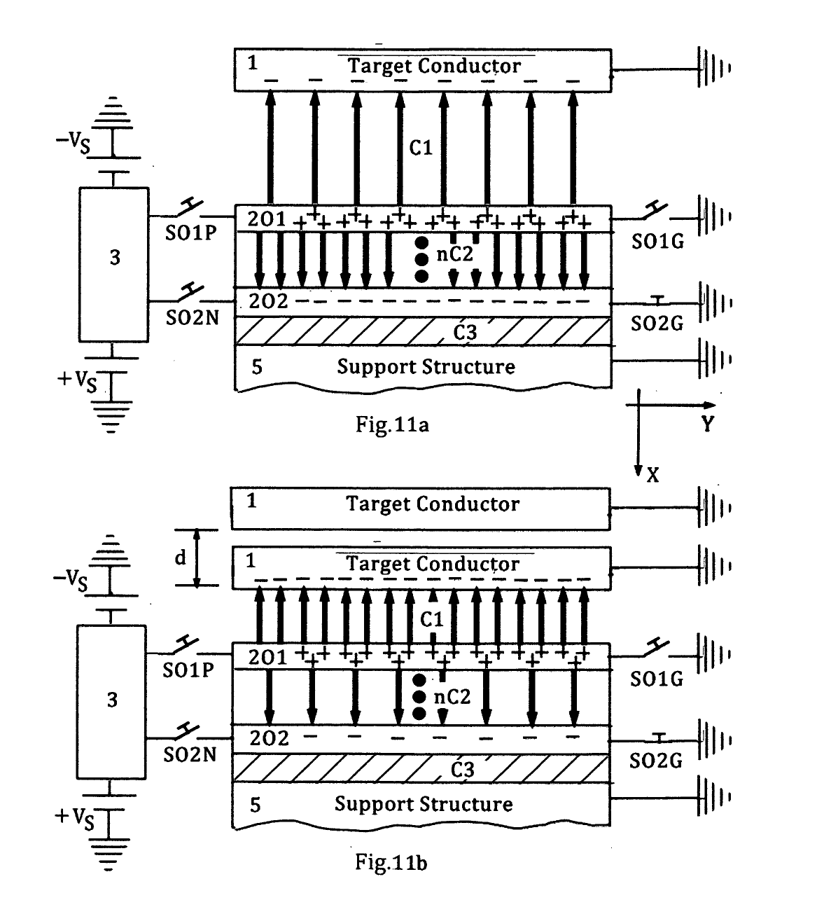

5). Moving Member (labeled 6 in FIGS. 10a, 10b, 11a and 11b). This applies for motor, generator and sensor applications.

### C. Operations

A Charge-Driven Electrostatic Induction System operates by first charging a stack of capacitors to emulate a series connection of multiple capacitors and, then using the stepped up voltage from said charged multi-electrode capacitor to induce significant charge in a target conductor separated by a thick insulator (typically air or vacuum) from said stack of capacitors. Stack charging is done in a series of steps so as to enable relatively small working level voltages to charge the individual capacitors in such that the stored charge and energy inside the stack of capacitors emulates that a series arrangement. That is, if the attack of capacitors were charged in series with a very large voltage the same arrangement of stored charge and energy would result.

The method by which electrodes of individual capacitors in said stack can be charged so as to create a result similar to series charging with much higher voltage will be illustrated as per FIGS. 2a, 2b and 2c. The method uses electrodes in groups of three, functioning as two back to back capacitors with a shared middle electrode. The first electrode E1 is connected to V_{S} through switch S1 and to electrical ground through switch SG1. The second electrode E2 is connected to V_{S} through switch S2 and to ground through switch SG2. The third electrode E3 is connected to V_{S} through switch S3 and to ground through switch SG3. I In the first step, the first electrode E1 is connected to a voltage source (say +V_{S}) and the middle electrode E2 is grounded. As a result positive charge is induced on said first electrode (E1) and equal negative charge is induced on said middle electrode E2. Both electrodes are disconnected and floated with charge trapped on each. The middle electrode E2 is then connected to +V_{S} and the third electrode E3 is connected to ground. Positive charge is induced on said middle electrode E2 and equal negative charge is induced on said third electrode E3. Again said voltage source and said ground are disconnected and the induced charges are trapped on their electrodes. The middle electrode E2 has both positive and negative charge trapped on it. In this example the negative charge is trapped on the middle electrode E2 surface nearest the first electrode E1 and the positive charge is trapped on the middle electrode E2 surface nearest the third electrode E3. Electrical energy is stored in the dielectric films between said electrodes E1 and E3. Electrode E1 is charged positive and electrode E3 is charged negative with electrode E2 charged both positive and negative in emulation of the two capacitors being charged in series with +2V_{S}. The process can be repeated until an entire stack of multiple capacitors is charged as if in series. It is possible to double the amount of electric charge on each of the electrodes by using +V_{S} as source voltage and −V_{S} as the termination potential, rather than ground. The same charge steps apply. We will return to this discussion in more detail, later.

Using stored energy in a series stack of charged capacitors to induce charge across a large insulation gap is distinct from using an equivalent large voltage source. The stack of capacitors transfers electric energy from internal storage to the insulation gap and the fixed charge distribution on the external electrode nearest said gap adjusts accordingly as does the remainder of the charge in said stacked capacitors. An equivalent very large voltage source would have to supply charge according to the basic equation relating charge, voltage and a a stack of multiple capacitors connected in series. These differences and their ramifications will be discussed in more detail, later.

Speed of operation is maintained even though multiple steps are required by charging a multiple capacitor stack as three sets of parallel capacitors and then trapping the charges so as to leave a stored charge and energy arrangement emulating a series charged capacitor. With this method, a stack of 100 or more capacitors can be charged in three steps and high speed ac operations can be conducted. We will also return to this in more detail.

### 1. Charging Method.

The Charging Method will be discussed in steps. In the step a), the Charging Method will be discussed for the Isolated Three-Electrode case, with no Target Conductor nearby. In step b), a grounded Target Conductor will be positioned nearby the charged Three-Electrode Capacitor of the first step so the reader can see how the trapped charge on the Three-Electrode Capacitor re-arranges itself to induce charge in said grounded Target Conductor and store electrical energy in the air gap that separates said grounded Target Conductor and said three electrode capacitor. This will illustrate differences in electrostatic induction using trapped charge sources and electrostatic induction using voltage sources in the simplest case. We now begin to add some real world complexity, so in step c) we have said grounded Target Conductor present when we charge said three-electrode capacitor. This illustrates charge formation, electrostatic induction and charge arrangement during expected operational circumstances.

a). Isolated Three-Electrode Case (FIGS. 2a, 2b, 2c). This will enable the reader to see how charge forms in the stack of capacitors with minimum complicating factors. It will clearly illustrate how capacitors can be charged in parallel to emulate a series charge arrangement. When the first electrode E1 is connected to a voltage source +V_{S} and the middle electrode E2 is connected to ground as per FIG. 2a, a positive charge is formed on electrode E1 and an equal but opposite negative charge is formed on electrode E2 according to Q=V_{S}/C [1]. The Ground and voltage connections are then opened, leaving positive charge trapped on E1 and negative charge trapped on E2, with electrical energy stored in the dielectric film between E1 and E2. The charge on E1 are on the electrode surface nearest E2 and the charge on E2 is on the electrode surface nearest E1. Next, +V_{S} is connected to electrode E2 and third electrode E3 is connected to ground as per FIG. 2b, A charge +Q forms on said the electrode E2 surface nearest electrode E3 and a −Q charge forms on the E3 electrode surface nearest E2. This leaves us with positive charge on one surface of E2 and negative charge on the other surface of E2 while E2 is connected to +V_{S}. The negative charge on E2 is attracted to both the positive charge on E1 and to voltage source +V_{S}. It stays in place so when the ground connection to E3 is opened, followed by opening the connection between E2 and +V_{S}, both positive and negative charges are held in place on E2, while positive charge is trapped on E1 and negative charge is trapped on E3. Why doesn't the negative charge on E2 get removed by +V_{S} and what does this imply? The negative charge on E2 is not removed by +V_{S} because to do so would move the system away from its minimum available energy state and violate conservation of energy. With the negative charge on E2 removed, the positive charge on E1 would be forced to induce charge in the nearest available conductor other than E2 and the energy expended to do so would be greater than the energy expended to hold negative charge on E2, even against +V_{S}. And, what does this imply? It implies the voltage on E1 has increased to the point where V_{E1}−+V_{S}=+V_{S}, V_{E1}=+2V_{S}.

The resulting charge arrangement is similar to what would occur if the Three-Electrode Capacitor had been charged by +2V_{S} voltage across electrodes E1 and E3 and the energy stored in the dielectric layers between E1, E2 and E3 also matches the series charge arrangement. The positive charge on E1 and the negative charge on E3 match the series charge arrangement. The middle electrode E2 does also, with a negative charge on its surface nearest E1 and a positive charge on its surface nearest E3. This means we have a +2V_{S} potential difference between E1 and E3, even though only +V_{S} has been used to charge the capacitor(s).

b). Grounded Target Conductor introduced after Charging (FIGS. 3a, 3b). When a grounded Target Conductor is brought near a Three-Electrode Capacitor charged in said series configuration as per FIG. 3b, said positive charge on electrode E1 can store energy in C1 and C2, rather than C2 only. As per conservation of energy, it will pick a combination of C1 and C2 which is stores the least amount of energy. The portion of positive charge that is stored in C1 subtracts from the charge available to store energy in C2. The total amount of negative charge on electrode E3 is reduced accordingly. With said three electrodes E1, E2 and E3 working in series, the charge on both surfaces of middle electrode E2 are reduced by an amount equal to the amount of charge diverted to C1. The charge reduction on middle electrode E2 is accomplished by some negative charge on one surface of middle electrode E2 combining with an equal amount of positive charge on the other surface of E2 and the remaining excess of negative charge on electrode E3 dispersing back into ground.

These adjustments are reflected in eq. (1).

Q₁=Q₁₁+Q₁₂ [2] eq. (1)

Where Q₁ is the total charge trapped on electrode E1, Q₁₂ is the charge on E1 that capacitively couples by capacitance with E3 (with E2 as an intermediary) and Q₁₁ is the charge on E1 that couples by capacitance with Target Conductor 1 across capacitance C1. C2 is the capacitance between electrodes E1 and E2 and between E2 and E3.

The voltage on E1 is:

Q₁₁/C1=Q₁₂/0.5C2 [3] eq. (2)

Which provides information on the charge distribution on E1 as per:

Q₁₁/Q₁₂=2C1/C2 eq. (3)

From equations (1) and (3) we have:

$$\begin{matrix}{Q}_{11} = {Q}_{1} - \frac{{Q}_{11} C 2}{2 C 1} \\ Or & eq . ( 4 ) \\ {Q}_{11} = \frac{{Q}_{1}}{1 + \frac{C 2}{2 C 1}} & eq . ( 5 )\end{matrix}$$

So we can see that some of Q₁ is diverted from coupling with E3 to coupling with Target Conductor 1 and we postulate the charge and voltages on E2 and E3 must adjust accordingly. The amount of charge available to couple with E2 and E3 has been reduced so there is less attractive electrostatic force to hold charge on E3 and the charge on E3 disperses back into ground until a new balance is restored at a lower level. E2 responds by reducing the positive charge on one surface and the negative charge on the other surface by allowing limited charge cancellation (or recombination) consistent with the new balance point. The charge neutrality of E2 is unchanged.

If E3 is disconnected from ground before Target Conductor 1 is introduced, it seems Q₁₁=0 because the positive charge on E1 is balanced by a trapped negative charge on E3 and by Gauss' Law of Charge, the electric flux is zero outside the closed system E1, E2, E3. When E3 is grounded, the system seeks the balance just described. Once the balance is reached and Q₁₁ comes into existence, E3 can be connected and disconnected to ground with no effect on Q₁₁.

c). Grounded Target Conductor present during Charging.

When a grounded Target Conductor is present throughout a charging cycle, additional electric energy is stored in C1 during the charge cycle as per FIGS. 4a and 4b. A portion of this additional energy is stored in C1 while electrode E1 and electrode E2 are charged and energy stored in C2 as per a) and b) above, with the remainder stored in another C2 when electrodes E2 and E3 are charged. The potential of electrode E1 is raised to +V_{S} during the first step in charging, while extra charge is added to and trapped on E1, with charge on both surfaces of E1. The first electrode. The potential of said first electrode is raised to approximately +2V_{S} during the second step in charging and more of the charge trapped on it links with said grounded Target Structure. No additional charge is added to the first electrode during this second stage.

The added extra charge on said first electrode is given as:

ΔQ₁₁=V_{S}C1=ΔQ₁, ΔQ₂=0 eq. (6)

For a total charge trapped on E1 of:

$$\begin{matrix}{Q}_{1} = {V}_{S} ( C 1 + C 2 ) , C 2 ≫ C 1 \\ Or & eq . ( 7 ) \\ {Q}_{11} = \frac{{Q}_{1}}{1 + \frac{C 2}{2 C 1}} \approx 2 {V}_{S} C 1 , where C 2 ≫ C 1 & eq . ( 8 )\end{matrix}$$

We note, as per FIGS. 5a and 5b, that grounding or floating electrode E3 has an effect on the amount of electrostatic charge induced in said grounded Target Conductor. When said third electrode is disconnected from ground before said middle electrode is disconnected from +V_{S}, as per FIG. 5a, an amount of negative charge is trapped on said third electrode that is equal and opposite to the positive charge on said middle electrode. This trapped negative charge acts to hold the positive charge on said middle electrode in place and inhibits charge combination/cancellation in said middle electrode, thereby inhibiting charge induction between said first electrode and grounded Target Conductor. When, thereafter, said third electrode is connected to ground, the negative charge on said third electrode is no longer trapped in place and can be reduced to accommodate the most efficient energy storage arrangement in C1 and both C2 dielectric layers. This results in more energy storage in C1 and more induced charge on said grounded Target Conductor, as per FIG. 5b. This happens because charge induced in a capacitor is held in place by a balance between applied voltage and dispersive forces in the charge. When the charge is trapped before the applied voltage is removed, the dispersive forces are physically opposed by the boundaries of the electrodes. When the electrode is grounded, dispersive forces spread the charge until a new balance is reached where more energy is stored in C1 and more charge is induced in Target Conductor 1.

### 2. Stack of Multiple Capacitors

We note that a Three-Electrode Capacitor, charged to emulate a series capacitor between said first and third electrodes has an approximately 2V_{S} potential on its outer electrodes while a Two-Electrode Capacitor has V_{S}. We can repeat the pattern by adding a fourth electrode E4 and third dielectric film to obtain approximately +3V_{S} between electrodes E1 and E4. In this instance said third electrode would be connected to source voltage V_{S} and capacitance coupled to a grounded fourth electrode. The resulting added positive charge could be trapped on said third electrode and we would have +3V_{S} between said electrodes E1 and E4 with net positive charge on said electrode E1, net negative charge on said electrode E4 and self-cancelling positive and negative charges on electrodes E2 and E3. This process can be continued until one hundred or more capacitors are added to the stack.

For the n capacitors stacked in series, we estimate the effective series capacitance of the stack as:

C_{ST}=C₂/n [4] eq. (9)

Q₁ trapped on electrode E1 in a stack of n capacitors in series has two parallel capacitance paths to ground, C₁ and C_{ST}=C₂/n.

### So:

$$\frac{{Q}_{11}}{{Q}_{ST}} = \frac{{C}_{1}}{{C}_{ST}} or {Q}_{ST} = {Q}_{11} \frac{{C}_{ST}}{{C}_{1}} \qquad eq . ( 9 a )$$

This leads to

$${Q}_{11} + {Q}_{11} \frac{{C}_{ST}}{{C}_{1}} = {Q}_{1} or {Q}_{11} ( 1 + \frac{{C}_{ST}}{{C}_{1}} ) = {Q}_{1} \qquad eq . ( 9 b )$$

Which simplifies to:

Q₁C₁=Q₁₁(C₁+C_{ST}) eq. (9c)

### Resulting in:

$$\begin{matrix}{Q}_{11} = {Q}_{1} ( \frac{C 1}{C 1 + {C}_{ST}} ) \\ = {Q}_{1} ( \frac{nC 1}{nC 1 + C 2} ) \\ = {V}_{S} C 2 ( \frac{nC 1}{nC 1 + C 2} )\end{matrix} \qquad eq . ( 10 )$$

Without using stacked capacitors we could expect an induced charge of:

Q₁₀=V_{S}C1 eq. (11)

Dividing eq. 10 by eq. 11 we find:

$$Gain = \frac{{Q}_{11}}{{Q}_{10}} = \frac{{V}_{S} C 2 nC 1}{{V}_{S} C 1 ( nC 1 + C 2 )} = \frac{nC 2}{nC 1 + C 2} \qquad eq . ( 12 )$$

### 3. Charge-Driven vs Voltage-Driven Electrostatic Induction.

Charge-Driven Electrostatic Induction has operating characteristics that differ from Voltage-Driven Electrostatic Induction, particularly when capacitors are used to supply the charge-drive. In some respects a capacitance-based Charge-Drive is analogous to a current source. There is a fixed amount of current available in a current drive and there is a fixed amount of trapped charge available in capacitance-based Charge-Drive. But, capacitance-based Charge-Drive has a unique problem in separating the charge. Charging a capacitor can yield equal and opposite charges in close proximity to each other. Even if the charges are large, if they are in close proximity to each other, their electric fields tend to cancel when we try to perform charge induction across a large insulation gap. Achieving charge separation and isolation is as important as achieving large charges. Electret devices use one method of achieving charge separation so charge-drive can be employed. This Invention uses a method to separate charge by the length of a stack of capacitors as its method. The method used in this invention can completely remove and return charge or can change polarity on command, while electret devices have a fixed polarity.

### 4. Speed of Operation (FIGS. 6, 7, 8 and 9).

To obtain proper charge separation using low voltage sources requires capacitive stacks with electrodes numbering in the hundreds. If we charge them one electrode at a time, responding to high frequency signals becomes problematic. We seek a means by which we can charge several at a time but, still obtain a series charge arrangement in the stack. We choose to organize the electrodes in groups of three, with a first, middle and third electrode in each group as illustrated in FIGS. 2a, 2b and 2c. We stack the groups on top of each other and connect all the first electrodes to a first common switching circuit, all the second electrodes to a second common switching circuit and all third electrodes to a third common switching circuit. The outer electrodes each have their own, independent switching circuit. A common voltage source(s) powers the entire stack. The two step charge sequence for a three electrode capacitor is applied as described in 1a), 1b), 1c), above, except that when the first step is performed, n/3 first electrodes and n/3 second electrodes are charged simultaneously. When the second step is performed, n/3 second electrodes and n/3 third electrodes are charged simultaneously. In this manner, a hundred or more electrodes can be charged in three steps and with high speed switching, a multi-layer stack can track high speed signals up to ⅓ the frequency of the switches.

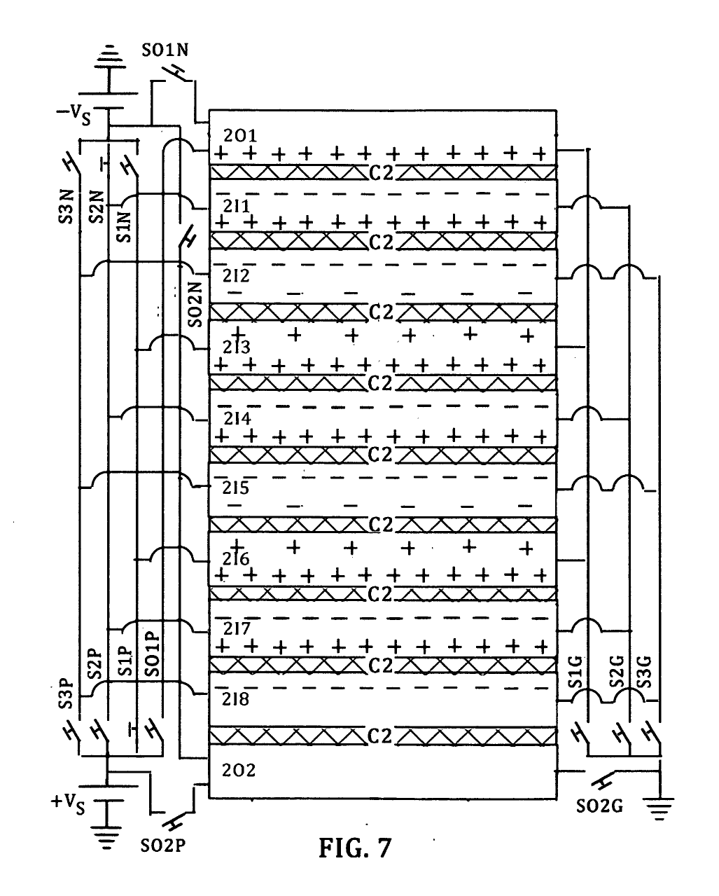

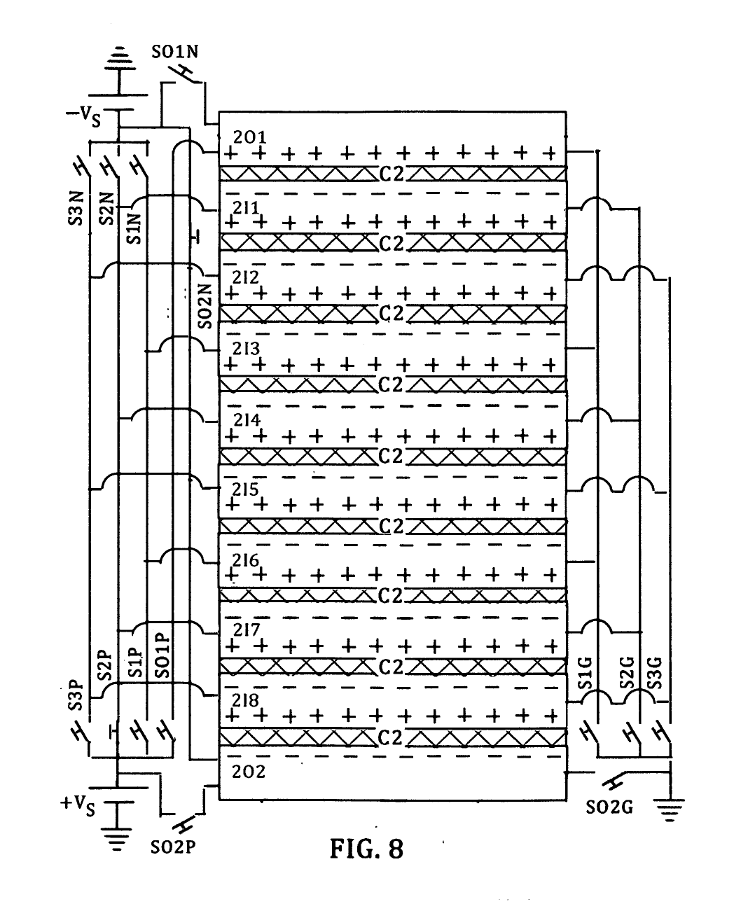

We now detail how this charging system will work. In the first step, all first set electrodes (2O1, 2I3, 2I6) are connected to source voltage +V_{S} and all second set electrodes (2I1, 2I4, 2I7) are connected to −V_{S} as per FIG. 6. All third set electrodes (2I2, 2I5, 2I8) are left floating. As a secondary effect, we see additional cross talk charge on the bottom surface of each second electrode. This charge is reduced by the separation caused by floating third set electrodes. We, then, trap the charge on all first and second electrodes. We trap the charge on the second set of electrodes fractionally before trapping charge on the first set of electrodes. In the second step, as per FIG. 7, we connect all second set electrodes to +V_{S} and all third set electrodes to −V_{S}. All first set electrodes are left floating with trapped charge in place. Positive charge is induced on all second set electrodes and equal and opposite negative charge is induced in all third set electrodes. The parasitic negative charge on all second electrodes is eliminated. No new parasitic charges are induced on the third electrodes because the only available electrodes are floating and unable to acquire or remove charge. The charge on the third set of electrodes is trapped fractionally before trapping the charge on trapping charge on the second set of electrodes. In the third step as per FIG. 8, all third set electrodes are connected to +V_{S} and all first set electrodes, with the exclusion of 2O1 and the inclusion of 2O2 are connected to −V_{S}. Again, the charge on the first set of electrodes is trapped fractionally before the charge on the third set of electronics is trapped. The charging detail described above shows 8 internal electrodes and two external electrodes but, it applies for many more so long as they can be connected in three groups plus an independent 2O1 and 2O2.

### D. Expected Prototype Performance

From eq. (13) above we can determine the effective voltage that can be applied to induce electrostatic charge in the Target Conductor and electric energy in the air/vacuum gap C1.

$$Gain = \frac{{Q}_{11}}{{Q}_{10}} = \frac{{V}_{S} C 2 nC 1}{{V}_{S} C 1 ( nC 1 + C 2 )} = \frac{nC 2}{nC 1 + C 2} \qquad eq . ( 13 )$$

Performance is measured as increased voltage across an insulation gap. We will assume the gap to be air or vacuum for our performance estimates.

We choose 3M embedded capacitance material C1011 [5] for our dielectric material between electrodes. This material is 0.00043 in thick with dielectric constant of 20. It has a dielectric strength of 3300 volt/mil and is tested to over 100 volts DC. This calculates to 1419 volts dielectric strength for our 0.43 mil thick layers. We assume operating voltages of 400 volts (+/−200 v using push pull operation). The dielectric layer is coated by copper 0.0015 in thick. The actual thickness of a capacitor is 0.00043+0.0015×2=0.00343 in. Of this, only 0.00043 in is used for separating the positive charges, which is critical to electrostatic induction. We expect we can reduce the copper thickness to 0.0005 in without any adverse effects, especially where multi-layer construction is employed as in our case.

For our case, we wish to penetrate an air/vacuum gap of 0.030 in. (typical for motor or noncontact energy transfer between moving joints). This means C2/C1=20(0.030)/0.00043=1395.3488372093

This makes our Gain

$$Gain = \frac{n 1395.3488372093}{n + 1395.3488372093} \qquad eq . ( 14 )$$

We want n as large as possible. We try 200=n. This provides a gain of 174.927113702624 to 1. Using multiple layers means increasing device thickness so we must now address this concern. For n layers of dielectric, we use n+1 electrodes.

(n+1)T_{L}=T_{D} eq. (15)

(200+1)(0.00093 in)=0.18693 in.=T_{D} (total device thickness)

eq. (16)

We choose V_{S}=200 volts, we obtain the electrostatic induction effects of 35 KV. Using V_{S}=±200 volts in a push pull configuration we obtain the electrostatic induction effects of 70 KV. We do not expect electric discharge to be a problem, 70 KV over 0.030 in is equivalent to 2.333 KV per mil. As stated earlier, the C1011 dielectric material has a dielectric strength of 3.3 KV per mil. In the event discharge does become a problem, source voltage can be lowered.

### E. Applications

An electrostatic induction system that can produce large electric fields over air or vacuum insulation gaps on the order of 0.030 in, has applications for motors, generators and power transfer units. These applications typically require magnetic induction across a 0.030 in air gap (because these applications involve two objects, moving with respect to each other and involving rolling bearings and the safe clearance allowed in this circumstance is on the order of 0.030 in). An electrostatic induction system that can produce large electric fields over air or vacuum gaps can also be applied where electrets had been previously used, such as electrostatic microphones and oscillating power generators or motors.

### 1. Motor Application Using Motion Transverse to E-Field

A motor application will now be described whereby a moveable, charge neutral conductor moves transverse to the E-Field projected into the air/vacuum gap C1, according to FIGS. 10a. and 10b. This applies to rotary electrostatic motors where rotor moves transverse to an electric field and to linear actuators supported by low friction bearings which prevent the slide from sticking to the walls. Projecting an electric field in an air/vacuum gap C1 and inducing charge in a remote structure beyond 1, stores electrical in the C1 gap, according to FIG. 10a, and a moveable member (labeled 6) moves transverse to the electric field and removes electrical energy from C1, by providing an easier path across C1. The rate of change of stored energy with respect to transverse motion of moveable member 6 determines the force on the moveable member. When the projected E-Field is collapsed, as in FIG. 10b, the force is removed. This type of motor can use poles or it can act as solenoid with limited movement and is analogous to electromagnetic pole motor and solenoid devices.

Energy stored in field reduces as capacitance of moving member increases. We want the amount of energy in an air gap. The force is the rate of change of energy in the air gap. The energy is

$$\begin{matrix}( {C}_{11} + {C}_{12} + {C}_{13} ) V = {Q}_{1} = {V}_{S} ( {C}_{1} + {C}_{2} ) = const & eq . ( 17 ) \\ V = {Q}_{1} / ( {C}_{11} + {C}_{12} + {C}_{13} ) & eq . ( 18 ) \\ \frac{1}{2} ( {C}_{11} + {C}_{12} ) {V}^{2} = {E}_{G} ( stored energy in air gap ) & [ 6 ] q . ( 19 )\end{matrix}$$

### 1a). Linear Motor

dE_{G}/dX=\vec{F}_{X}=V(dV/dX)(C₁₁+C₁₂)+(½)V²(dC₁₁/dX+dC₁₂/dX) [7] eq. (20)

### Where:

C₁₁=ε₀A₁₁/d₁₁, C₁₂=ε₀A₁₂/d₁₂, A₁₁=WX, A₁₂=W(X₀−X)

dC₁₁/dX=ε₀W/d₁₁, dC₁₂/dX=ε₀W(−1)/d₁₂

### And:

$$\frac{d V}{d X} = {( {C}_{11} + {C}_{12} )}^{- 1} \frac{d {Q}_{1}}{d X} + {Q}_{1} ( - 1 ) {( {C}_{11} + {C}_{12} )}^{- 2} ( \frac{d {C}_{11}}{d X} + \frac{d {C}_{12}}{d X} )$$

$$\frac{d {Q}_{1}}{d X} = 0 ( because trapped charge {Q}_{1} is constant )$$

### So:

dV/dX=−Q₁(C₁₁+C₁₂)⁻²(ε₀W)(1/d₁₁−1/d₁₂)

### Where:

$${C}_{11} = \frac{{ɛ}_{0} WX}{{d}_{11}} , \\ {C}_{12} = \frac{{ɛ}_{0} W ( L - X )}{{d}_{12}} , \\ L = Constant$$

### So:

dV/dX=−V_{S}(C₁+C₂)(ε₀W)⁻²(1/d₁₁−1/d₁₂)⁻²(ε₀W)(1/d₁₁−1/d₁₂)

### Where:

Q₁=V_{S}(C₁+C₂)

This simplifies to:

dV/dX=−V_{S}(C₁+C₂)(ε₀W)⁻¹(1/d₁₁−1/d₁₂)⁻¹

We plug this into eq. 20 resulting in:

\vec{F}_{X}=−VV_{S}(C₁+C₂)(ε₀W)⁻¹(1/d₁₁−1/d₁₂)⁻¹+0.5 V²(ε₀W)(1/d₁₁−1/d₁₂) eq. (21)

### 1b) Rotary Motor

We will now examine the rotary motor case.

$$\begin{matrix}E = 1 / 2 {CV}^{2} ( energy stored in air gap ) & eq . ( 22 ) \\ \frac{d E}{d θ} = F {{a}^{->}}_{θ} = \frac{{V}^{2}}{2} \frac{d C}{d θ} + CV \frac{d V}{d θ} \\ Where \text{:} & [ 8 ] eq . ( 23 ) \\ C = {C}_{11} + {C}_{12} + \frac{{C}_{2}}{n} & eq . ( 24 ) \\ ( {C}_{11} + {C}_{12} + \frac{{C}_{2}}{n} ) V = {V}_{S} {C}_{2} ( constant ) and \\ \frac{{C}_{2}}{n} is constant & eq . ( 25 ) \\ \frac{d ( {C}_{11} + {C}_{12} + \frac{{C}_{2}}{n} )}{d θ} V + \frac{d V}{d θ} ( {C}_{11} + {C}_{12} + \frac{{C}_{2}}{n} ) = 0 & eq . ( 26 ) \\ \frac{d C}{d θ} V = - \frac{d V}{d θ} C & eq . ( 27 ) \\ F {{a}^{->}}_{θ} = \frac{{V}^{2}}{2} \frac{d C}{d θ} - {V}^{2} \frac{d C}{d θ} = - \frac{{V}^{2}}{2} \frac{d C}{d θ} & eq . ( 28 ) \\ d T {{a}^{->}}_{θ} = R d F {{a}^{->}}_{θ} & eq . ( 29 ) \\ \frac{d F}{d R} d R = - \frac{{V}^{2}}{2} \frac{{d}^{2} C}{d θ d R} d R = d F \\ ( V is considered invariant over R ) & eq . ( 30 ) \\ d T = R d F & eq . ( 31 )\end{matrix}$$

We now perform steps to determine dF. We begin by determining C.

$$\begin{matrix}C = \frac{{ε}_{0}}{{d}_{11}} {\int }_{R 1 ,}^{R2 ,} {\int }_{0}^{θ} R d θ d R + \frac{{ɛ}_{0}}{{d}_{12}} {\int }_{R 1 ,}^{R 2 ,} {\int }_{θ}^{{θ}_{0}} R d θ d R + \frac{{C}_{2}}{n} & eq . ( 32 ) \\ OR \text{:} & \\ C = \frac{{ε}_{0}}{{d}_{11}} θ {\int }_{R 1}^{R 2} R d R + \frac{{ε}_{0}}{{d}_{11}} ( {θ}_{0} - θ ) {\int }_{R 1}^{R 2} R d R + \frac{{C}_{2}}{n} & eq . ( 33 )\end{matrix}$$

### Resulting in:

$$\frac{{d}^{2} C}{d θ d R} = \frac{{ε}_{0}}{{d}_{11}} R - \frac{{ɛ}_{0}}{{d}_{12}} R , where \frac{d \frac{{C}_{2}}{n}}{d θ} = 0 \qquad eq . ( 34 )$$

Substituting the results of eq. (34) into eq. (20) results in:

$$d F = - \frac{{V}^{2}}{2} ( \frac{{ε}_{0}}{{d}_{11}} R - \frac{{ɛ}_{0}}{{d}_{12}} R ) d R \qquad eq . ( 35 )$$

Substituting the results of eq. (35) into eq. (31) results in:

$$\begin{matrix}d T = R d F = - \frac{{V}^{2}}{2} {ɛ}_{0} ( \frac{1}{{d}_{11}} - \frac{1}{{d}_{12}} ) {R}^{2} d R \\ So \text{:} & eq . ( 36 ) \\ \vec{T} = {\int }_{R 1}^{R 2} d T = - \frac{{V}^{2}}{2} {ɛ}_{0} ( \frac{1}{{d}_{11}} - \frac{1}{{d}_{12}} ) \frac{{R}^{3}}{3} {\vec{d}}_{z} & eq . ( 37 )\end{matrix}$$

We know that V is a function of θ so we calculate V for the angle we are considering, using known design parameters and eq. 39. We then substitute the value for V back into eq 38 to calculate torque.

From eq. (33) we have:

$$C = \frac{{ε}_{0}}{{d}_{11}} θ {\int }_{R 1}^{R 2} R d R + \frac{{ε}_{0}}{{d}_{11}} ( {θ}_{0} - θ ) {\int }_{R 1}^{R 2} R d R + \frac{{C}_{2}}{n} \qquad eq . ( 33 )$$

This computes to:

$$C = ( \frac{{R}_{2}^{2} - {R}_{1}^{2}}{2} ) ( {ɛ}_{0} \frac{θ}{{d}_{11}} + {ɛ}_{0} \frac{{θ}_{0} - θ}{{d}_{12}} ) + \frac{{C}_{2}}{n} \qquad eq . ( 38 )$$

We are working with a fixed amount of trapped Charge V_{S}C₂ which will distribute itself between C₁₁ and C₁₂ as per:

$$V ( \frac{{R}_{2}^{2} - {R}_{1}^{2}}{2} ) ( {ɛ}_{0} \frac{θ}{{d}_{11}} + {ɛ}_{0} \frac{{θ}_{0} - θ}{{d}_{12}} + \frac{{C}_{2}}{n} ) ≅ {V}_{S} {C}_{2} \qquad eq . ( 39 )$$

Thus we can calculate V for any θ using eq. (39) and can substitute that V into eq. (37) to determine \vec{T}.

### 2. Motor Application Using Motion Parallel to the E-Field

A motor application will now be described whereby a moveable, grounded electrical conductor 1 moves to increase or decrease the air/vacuum gap according to FIGS. 5a and 5b. This applies to oscillation type motors, to electrets microphone type devices and to energy conversion devices (mechanical to electrical or electrical to mechanical). When a moveable grounded electrical conductor moves to reduce the size of an air/vacuum gap as per FIG. 5a, the stored electrical energy in the gap is reduced and force is applied to the conductor 1 proportional to the rate of change of energy stored in gap C1 divided by rate of change of gap size. When the E-Field is collapsed according to FIG. 5b, the force on 1 is removed and the moveable conductor 1 is free to return to its starting position, possibly by spring return.

$$\begin{matrix} {V}_{X} ( {C}_{X} + \frac{{C}_{2}}{n} ) = {V}_{S} ( {C}_{0} + {C}_{2} ) = const & eq . ( 40 ) \\ {C}_{X} = {ɛ}_{0} \frac{A}{X} & eq . ( 41 ) \\ {V}_{X} ( \frac{{ɛ}_{0} A}{X} + \frac{{C}_{2}}{n} ) = {V}_{S} ( {C}_{0} + {C}_{2} ) & eq . ( 42 ) \\ {V}_{X} = \frac{{V}_{S} ( {C}_{0} + {C}_{2} )}{( \frac{{ɛ}_{0} A}{X} + \frac{{C}_{2}}{n} )} & eq . ( 43 ) \\ E = \frac{1}{2} ( {C}_{X} + \frac{{C}_{2}}{n} ) {V}_{X}^{2} & eq . ( 44 ) \\ {\vec{F}}_{X} = \frac{d E}{d X} = \frac{{V}_{X}^{2}}{2} \frac{d ( {C}_{X} + \frac{{C}_{2}}{n} )}{d X} + ( {C}_{X} + \frac{{C}_{2}}{n} ) {V}_{X} \frac{d {V}_{X}}{d X} & eq . ( 45 ) \\ \frac{d {V}_{X} ( {C}_{X} + \frac{{C}_{2}}{n} )}{d X} = {V}_{X} \frac{d ( {C}_{X} + \frac{{C}_{2}}{n} )}{d X} + ( {C}_{X} + \frac{{C}_{2}}{n} ) \frac{d {V}_{X}}{d X} = 0 & eq . ( 46 ) \\ {V}_{X} \frac{d ( {C}_{X} + \frac{{C}_{2}}{n} )}{d X} = - ( {C}_{X} + \frac{{C}_{2}}{n} ) \frac{d {V}_{X}}{d X} & eq . ( 47 ) \\ {\vec{F}}_{X} = \frac{{V}_{X}^{2}}{2} \frac{d ( {C}_{X} + \frac{{C}_{2}}{n} )}{d X} - {V}_{X}^{2} \frac{d ( {C}_{X} + \frac{{C}_{2}}{n} )}{d X} = - \frac{{V}_{X}^{2}}{2} \frac{d ( {C}_{X} + \frac{{C}_{2}}{n} )}{d X} & eq . ( 48 ) \\ \vec{F} = - {\frac{1}{2} [ \frac{{V}_{S} ( {C}_{0} + {C}_{2} )}{( \frac{{ɛ}_{0} A}{X} + \frac{{C}_{2}}{n} )} ]}^{2} {ɛ}_{0} \frac{A}{X} & eq . ( 49 ) \\ E = \frac{1}{2} {( {ɛ}_{0} \frac{A}{X} + \frac{{C}_{2}}{n} ) [ \frac{{V}_{S} ( {C}_{0} + {C}_{2} )}{( \frac{{ɛ}_{0} A}{X} + \frac{{C}_{2}}{n} )} ]}^{2} & eq . ( 50 )\end{matrix}$$

### 3. Power Transfer Application

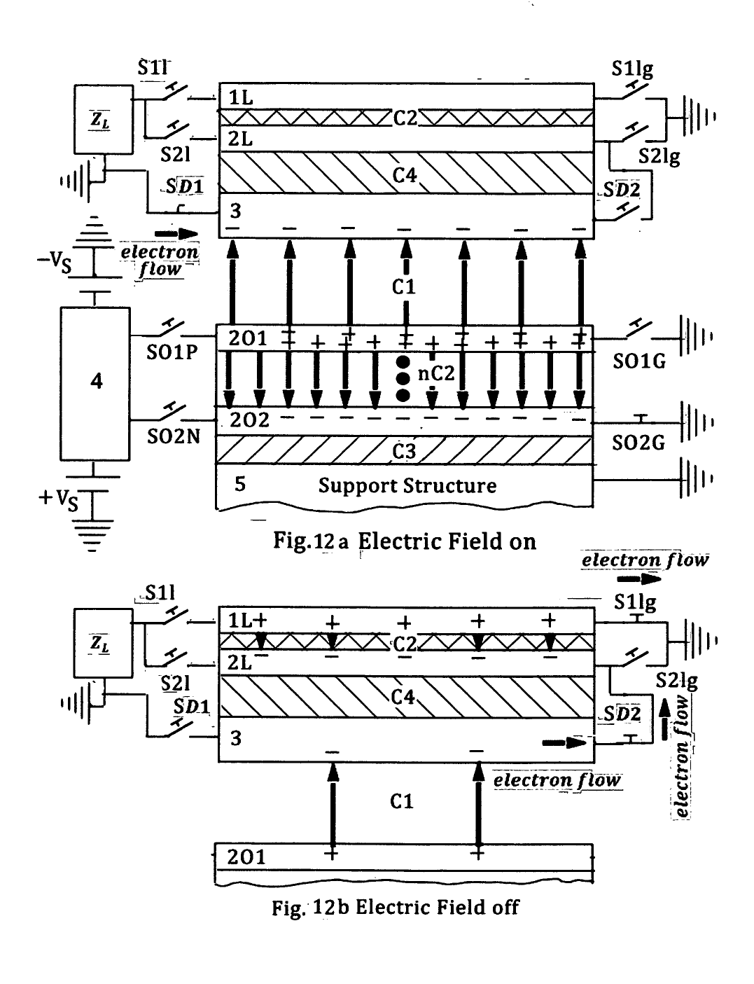

A Power Transfer application, according to FIGS. 12a and 12b will now be described. When an E-Field is projected into an air/vacuum gap C3, opposite charge is induced in conductor 3 according to FIG. 12a. This charge comes from the grounded structure to electrode 3 through switch SD1, while switch SD2 is left open to isolate activities on electrode 3 from electrodes 1L and 2L. Also, switches S2Ig, S22g, S2I and S1I are left open to leave electrodes 1L and 2L isolated from load (Z_{L}) and from ground. At the same time, switches SO1P, SO1N, SO1g and SO2g are left open to facilitate trapping charge on electrode 2O1 to power the charge induction on electrode 3. When the E-Field is removed, according to FIG. 12b, the induced charge on electrode 3 experiences forces of dispersion. Switches SD2 and SI1g are, then, closed and SD1 is opened to allow the electrode 3 charge to disperse to electrode 2L and to attract equal and opposite charge on 1L. The capacitance between 1L and 2L is large to maximize the charge on 1L and 2L and to minimize the charge remaining on electrode 3. This process can be continued for several cycles in a charge pumping action until charge on electrodes 1L and 2L are equal to the peak charge on electrode 3. When sufficient charge is accumulated on electrodes 1L and 2L, this stored charge can be used to power load Z_{L}. As shown in FIG. 12, the load is powered by positive charge when S1Ig is opened, S1I is closed and 2Ig is closed.

The load is powered by negative charge when S2Ig is opened, S2I is closed to load and S1I is opened and S1Ig is closed. When discharge through Z_{L} is completed, the system can be reconfigured to begin charging again.

With this introduction we will introduce the equations for predicting performance and providing design guidance for specific device applications. We will, first estimate the amount of charge that can be induced across an air/vacuum gap followed by the power that can be transferred across the gap. The power transfer function equations are similar to those used for a motor application where movement is in the direction of the electric field except that there is no motion and the capacitance of the air/vacuum gap is constant and electrostatic force across the air/vacuum gap is not a factor.

$$\begin{matrix} {V}_{X} ( {C}_{1} + \frac{{C}_{2}}{n} ) = {V}_{S} ( {C}_{1} + {C}_{2} ) = const \\ {V}_{S} ( {C}_{1} + {C}_{2} ) = charge trapped on 201 & eq . ( 51 ) \\ {C}_{1} = {ɛ}_{0} \frac{A}{X} & eq . ( 52 ) \\ {V}_{X} ( \frac{{ɛ}_{0} A}{X} + \frac{{C}_{2}}{n} ) = {V}_{S} ( {C}_{1} + {C}_{2} ) & eq . ( 53 ) \\ {V}_{X} = \frac{{V}_{S} ( {C}_{1} + {C}_{2} )}{( \frac{{ɛ}_{0} A}{X} + \frac{{C}_{2}}{n} )} & eq . ( 54 ) \\ E = \frac{1}{2} ( {C}_{1} + \frac{{C}_{2}}{n} ) {V}_{X}^{2} ( total electric energy stored in system ) & eq . ( 55 ) \\ E = \frac{1}{2} ( {C}_{1} ) {V}_{X}^{2} ( electric energy stored in air / vacuum gap ) & eq . ( 56 ) \\ {Q}_{1} = {V}_{X} {C}_{X} ( electric charge induced across air / vacuum gap & eq . ( 57 )\end{matrix}$$

### 3a). Dispersion

With V_{X} set to zero, Q₁ disperses and seeks the nearest ground. It has two choices, C₁ and C₂ and it will prefer C₂ by a C₂/C₁ ratio.

$$\begin{matrix}{V}_{X} {C}_{1} + {V}_{X} {C}_{2} = {Q}_{1} = {V}_{X} ( {C}_{1} + {C}_{2} ) = {V}_{X} {C}_{1} ( 1 + \frac{{C}_{2}}{{C}_{1}} ) & eq . ( 58 ) \\ {Q}_{2 L} = {V}_{X} {C}_{2} , {Q}_{11} = {V}_{X} {C}_{1} = {Q}_{1} - {Q}_{2 L} ( {C}_{2} ≫ {C}_{1} ) & eq . ( 59 )\end{matrix}$$

Equation 59 shows Q_{2L}>>Q₁₁ so most of the charge on electrode 1 moves to electrode 2L during dispersion, with multiple pumping steps not needed. This means nearly all the charge is transferred to 1L and 2L during each step and a relatively large current can be supplied to power Z_{L} on a continuous basis.

### 3b). Power

We start with the energy stored in a capacitor with electrodes 1L and 2L and examine how much power can be supplied to a load with this stored energy. We also examine how fast we can resupply the stored energy and how much sustained power can be delivered.

$$E = \frac{{Q}^{2}}{2 {C}_{2}} = \frac{{( {V}_{X} {C}_{1} )}^{2}}{2 {C}_{2}} \qquad eq . ( 60 )$$

This capacitor must cycle between being charged and supplying current to Z_{L} and the speed of this cycle determines the rate of energy, or power, transferred.

### Cycle Sequence

1. The Stack is charged and charge is induced in electrode 1.
2. The Stack is discharged and the electric field from the Stack is collapsed. Simultaneously, charge on electrode 1 moves to electrode 1L, with equal and opposite charge simultaneous induced in 2L by capacitance.
3. Electric power is supplied to the load from energy stored in the capacitor using electrodes 1L and 2L and simultaneously and independently electrode 1 is charged as per step 1.
4. Repeat step 2.
5. Repeat step 3.

The cycle sequence uses two steps, but one of the steps requires charging the Stack, which requires three steps. Thus, in effect, we have a four step for each burst of energy that is supplied to the load. We choose a step frequency so we can achieve an ac load frequency of 25% of the step frequency. This suggests we speed up the drive frequency by a factor of four to obtain suitable power transfer frequency. Power transfer frequencies on the order of a ghz seem possible.

### 4. Generator Applications

Generation of electricity can be achieved in a reverse application of the electrostatic motors described in 1a and 1b above. In the generator application, an electric field is maintained in the air or vacuum gap by a charged stack of capacitors, the field is periodically changed by using mechanical power, induced ac electrical power is induced in the process and that induced electrical power is stored to be used as needed. The charged stack of capacitors maintains the electric field in the air or vacuum gap without external electrical power because it has charge trapped in place so we have a method and device for converting mechanical power to electrical energy or an electrostatic generator.

The charged Stack of Capacitors stores electrical energy in the air or vacuum gap as per eq. 56.

$$E = \frac{1}{2} ( {C}_{1} ) {V}_{X}^{2} ( electric energy stored in air / vacuum gap ) \qquad eq . ( 56 )$$

4a). Electrostatic Generators in which the Moving Member moves in a direction transverse to the electric field which stores energy in the air or vacuum gap.
4a1). Rotary Case

For a rotary electrostatic generator, mechanical power can be used to rotate a moving member as through an air or vacuum gap as shown in FIG. 10a. As shown in FIG. 10a, the electrical energy stored in the air or vacuum gap is disturbed as the Moving Member passes through it. This physically changes C₁ as per eq. 55 and, with it, E and V_{X}. When the Moving Member leaves the gap, E, C₁ V_{X} return to their original values and when the Moving Member re-enters the air or vacuum gap, the values of E, C₁ and V_{X} return to load values. These conditions can be physically changed in a periodic manner to produce ac induced current and this current, in turn, can be stored as electrical energy to be applied as needed. The frequency of the induced ac current is limited only by the physical rotation speed of the Moving Member. The output frequency of the stored electrical energy can be faster than Moving Member rotation rate. For example the stored electrical energy can be used to power an oscillator at a higher frequency and this oscillator can serve as the source of the output ac current.

4a2). Linear Case

A linear electrostatic generator can use mechanical power to oscillate back and forth through a region where the air or vacuum gap contains stored electric energy. This motion serves to generate induced ac current and stored electrical energy similar to that done by a rotary electrostatic generator. The circumstances and effects of FIG. 10a apply as do the effects as per eq. 56.

4b. Electrostatic Generators in which the Moving Member moves in a direction parallel to the electric field which stores energy in the air or vacuum gap.

In this application, a grounded Moving Member is moved by mechanical force in an air or vacuum gap with electric energy stored therein, with the movement parallel to the direction of the electric field supplying the electric energy in the gap. The movement in one direction causes the air or vacuum gap to decrease and the movement in the opposite direction causes the gap to increase as per FIGS. 11a and 11b. When the gap is decreased, electrical energy is taken from the gap and when the gap is increased, electric energy is added to the gap. The electric energy that is taken from the gap is stored external to the Electrostatic Generator hardware in a capacitor with the resultant electric field polarity opposite to the polarity of the electric field in the air or vacuum gap. The electric energy that is added to the air or vacuum gap induces a stored energy in a capacitor with the resultant field polarity in the direction of the polarity of the electric field stored in the air or vacuum gap. The circumstances and effects of FIGS. 11a and 11b apply as do the effects as per eq. 56 except that mechanical force and work is used to generate electrical energy rather than using electrical energy to cause mechanical force and motion. Equations 40 through 50 also apply except that force and displacement are to be interpreted as inputs and changes in electrical energy are to be interpreted as outputs.

### 4c). Charge-Driven Electrostatic Induction Generators in Energy Scavenger Applications

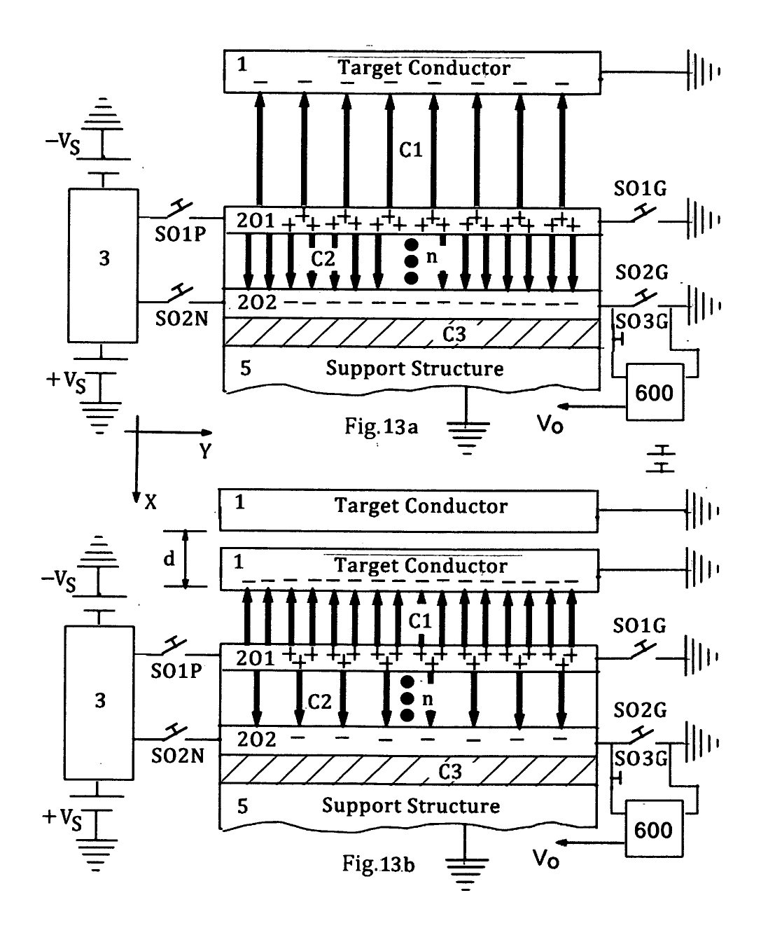

The Energy Scavenger application, according to FIGS. 15a, 15b, 16 and 9, induces charge on the Charged Stack ground electrode 202 when the Target Conductor 1 moves closer to Charged Stack electrode 201 and removes charge from electrode 202 when Target Conductor 1 moves away from electrode 201. Thus, charge on electrode 202 increases and decreases with the in and out motion of Target Conductor 1. The Energy Scavenger application uses a one-way diode between ground and 202 such that charge, originating from ground, can pass through the one-way diode to 202 during charge increase but, cannot return during periods of charge decrease. A second one-way diode allows charge to leave 202 by dispersion en route to a capacitor C5 (FIG. 13a) where it attracts equal and opposite charge from ground and stores energy in C5. This energy is available for use when switch S1 is closed (FIG. 13a) and C5 can recharged when S1 is opened. The limiting factor is when the charge stored in C5 has voltage equal to the dispersion voltage on 202. At this point, the excess charge on 202 cannot leave and the energy harvesting ceases. Using the stored energy keeps the energy harvesting process going. FIG. 13a shows a situation where negative charge is stored on 202 but, positive charge can be used by reversing the polarity of the diodes (FIG. 13a) in combination with using negative trapped charge on 201 (FIG. 9). Diodes are passive components and the trapped charge stored in the capacitive stack (labeled 4 in FIG. 1) so the entire energy scavenger system need not require external power and can remain in a sleep mode until sufficient energy is stored in C5. At this point the stored energy can be used to activate and operate electronic and electromechanical systems.

### 4d). Deformable Charge-Driven Electrostatic Induction Generators in Energy Scavenger Applications

The Energy Scavenger application (FIGS. 15a, 15b, 16 and 9) can take advantage of flexible structures to generate electrical energy. For example, articles of clothing can use human activity to generate electrical energy and power electrical and electromechanical devices. Such articles of clothing can be constructed in layers which are flexible in bending, with a thin insulation gap between the outer layers and inner layers such that the insulation gap is changes in response to wearer activity. The outer layer must be electrically conductive so it will act as a moveable target conductor, but the conductor can be very thin and can be embedded in the clothing material such that the clothing material can perform full function in its clothing role. The insulation gap must be capable of storing electrical energy, must be capable of allowing motion of the target conductor relative to the inner layers and must be capable of elastically restoring the target conductor to its original position when the external forces are removed. The inner layers would comprise a composite of stacked ultra-thin capacitors and clothing material such that inner layer composite can elastically bend, with full range of motion, and can perform both its clothing and generator functions, without hampering user motion. The stack of ultra-thin capacitors must be thin enough that it remains flexible in bending, but it must provide sufficient separation between the charge trapped on the outer layer nearest the insulation gap and the charge on the outer layer nearest the wearers' body. This can be compensated by reducing the thickness of the insulation layer, so enough additional trapped charge is being attracted to the moveable target conductor to compensate the loss of charge separation. Wearable Charge-Driven Electrostatic Generators require the dielectric film between the electrodes in the stack be able to withstand bending without cracking. This can be accomplished in a number of ways: 1. A stiff dielectric material can be used in regions where wearer movement requires limited bending with significant compression, 2. A composite of stiff and flexible binder can be used, 3. A flexible dielectric material can be used with reduced dielectric capabilities.

### 5. Sensor Applications

A Charge-Driven Electrostatic generator can function as a sensor. As shown in 4. GENERATOR APPLICATIONS, a Charge-Driven Electrostatic generator can provide stored electric energy in an insulation gap between an outer electrode on the generator and a grounded conductive moving member, with power off. When the generator moving member moves in response to an external time variable mechanical force, the electric energy stored in the gap is disturbed and the charge on the grounded outer electrode of the generator changes in a time variable manner. When a load is inserted between ground and the outer electrode, time varying electric power is driven through the load or storage device. The time varying electrical power going through the load produces a time varying voltage across the load and current through the load that can be sensed in frequency, phase and amplitude and information about the nature of the mechanical force driving the moving member is provided. The result is a sensor which measures the behavior of the mechanical force acting on the moving member.

### a). Microphone Application

When the moving member is a diaphragm being driven by sound, we have a microphone and this microphone is analogous to an electret microphone with some notable advantages. An electret is permanently polarized with a fixed surface charge. This charge attracts foreign elements with opposite charge which tend to degrade performance over time. A Charge-Driven Electrostatic Induction sensor can simply change the charge every so often and clean the offending foreign elements by repulsion. Also, current electret technology provides a limited ε_{R} so, the surface charge available is limited, which limits microphone performance as well. Embedded capacitor technology has a much better energy storage capability with an ε_{R}=20 and dielectric thicknesses as thin as 0.00043 in. [5]. This means that large amounts of electrical energy can be stored in a stack of capacitors using modest voltage sources. This also means that surface charge trapped on the outer electrode nearest the diaphragm can be large and microphone performance improved as a result. Another advantage for Charge-Driven Electrostatic Induction microphones are in their ability to measure signal at the grounded outer electrode. The charge on the grounded outer electrode changes with diaphragm movement so measurements can be taken by inserting a measuring system between the grounded outer electrode and ground. The electronics in such a measuring system would be relatively stationary and would be in a protected position. Diaphragm requirements for Charge-Driven Electrostatic Induction microphones and electret microphones are similar and are well within the state of the art. A passive sleep mode (as described in section 4c) above) can be used to reduce or eliminate battery requirements for a Charge-Driven Electrostatic Induction microphone. The method as applied to a microphone would be similar to that described in section 4c, but with application specific adjustments.

5a1). Sensing Method

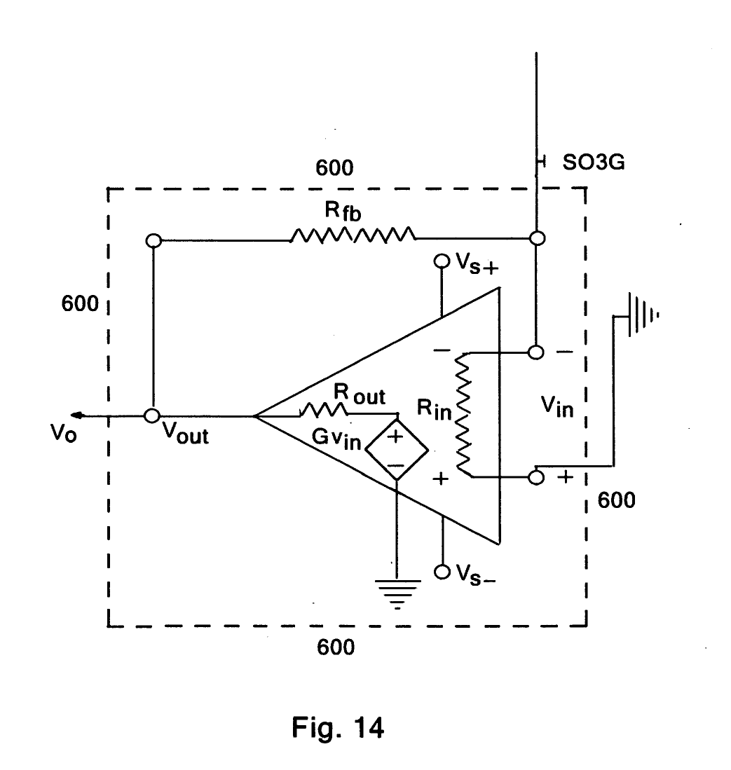

An application is illustrated, according to FIGS. 13a, 13b and 14 where a diaphragm (or moveable target conductor) moves and its mechanical oscillation is converted to electrical energy and where this electrical energy is manifested by charge addition or subtraction on either electrode 2O2 or the moveable target conductor 1. In FIGS. 13a, 13b and 14 we illustrate the case where the charge addition and charge subtraction on electrode 2O2 is directed by switches SO2G and SO3G to terminate on a driven ground [9], with this termination resulting in amplified voltage output according to FIG. 14. This is a charge breathing cycle in which charge is inhaled from ground through SO3G to terminate on the driven ground. Attaching the switches SO2G and SO3G and driven ground termination to 1 (moveable target conductor) provides the same result as attaching same to electrode 2O2.

5a2). Sensing Method Using Passive Electric Components

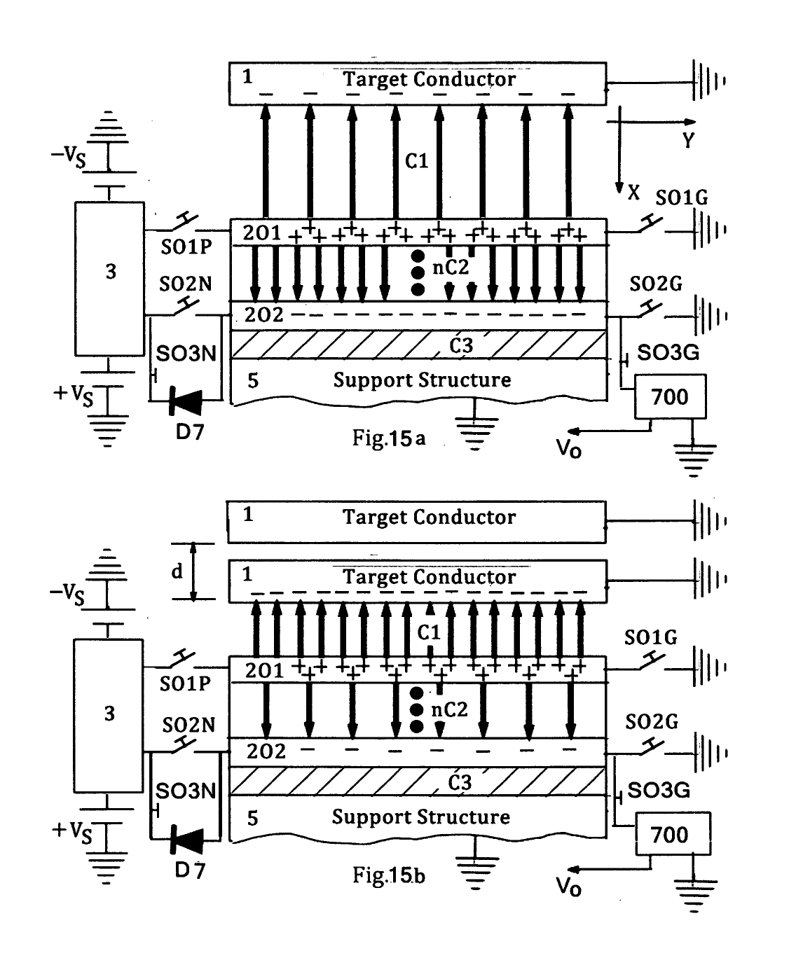

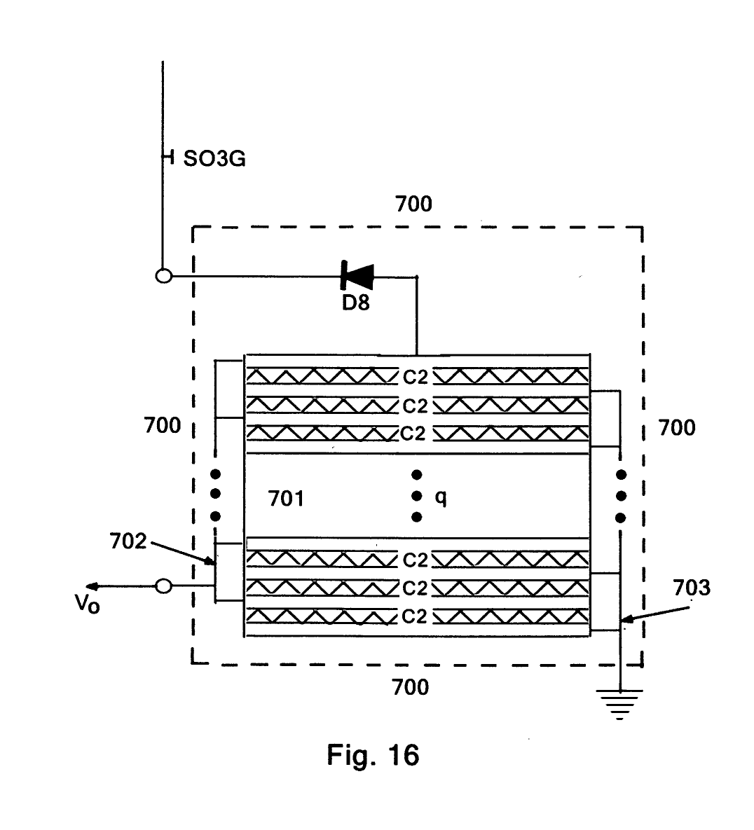

An application is illustrated, according to FIGS. 15a, 15b and 16 where electrical energy can be stored in a capacitor 701 while the microphone is in a sleep or passive mode. When sufficient energy is stored in 701, the switching system, SO2G and SO3G can be activated along with the driven ground termination and voltage output and the system can be operated like 5a1). This provides a method and apparatus to eliminate or reduce battery requirements. For continuous microphone operation without a battery, the input mechanical power supplied as electrical power to capacitor 701 must be equal to or greater than the electrical signal output power plus the electrical power needed to operate the electronics (including switches and op-amps) for continuous operation. Otherwise, operation must be intermittent.

5a3). Sensing Method Options

There is also the option of using 5a1) and 5a2) in combination whereby the device is operated in sleep mode until sufficient energy is accumulated to operate in active mode.

### 5b). Sensor Options

Any force or energy source which can disturb the electrostatic energy stored in the insulation gap can be sensed and measured, particularly if it is time variable. Some of these energy sources mechanically act on the moveable member. Some of these act on the moveable member indirectly through an intermediate member. Some of these operate on the electric energy stored in the insulation gap without moving the moveable member.

5b1) Sensors Using Mechanical Energy to Move the Moveable Member
(a) Direct mechanical force can move the moving member and disturb the electric energy stored in the insulation gap. Strain gauges, pressure gauges, weight measuring devices, accelerometers, etc.
(b) Indirect mechanical energy can be used to move the moveable member through an intermediate medium. In this way, temperature changes can be measured by introducing an expandable gas container between the moveable member and the heat source. The heat source expands the gas and the container expands with it. The container movement moves the moveable member and this movement is measured. In the process, temperature is measured.
   5b2) Sensors Using Sensing Methods that do not Move the Moveable Member
Energy sources can operate on the electric energy stored in the insulation gap without moving the moveable member. When electric energy is stored in the insulation gap, charge is trapped on the nearest Charge-Driven Electrostatic Induction outer electrode and opposite charge is induced on the grounded moveable member. When the moveable member is disconnected from ground the charge induced by the outer electrode is trapped on the moveable member. When a time varying electric field is introduced on the moveable member, a back time varying voltage is induced which affects the electric energy and can be measured by the Charge-Driven Electrostatic Induction sensor.

### F. Nuances and Error Approximations

In this section we examine the error that attends the assumption of net zero charge on the internal electrodes. We find that there is a slight net charge on each of the internal electrodes and that this net charge progressively increases as we go down the stack of electrodes. On the other hand, we also find that the error is not great and the net charge helps performance so we are left with confidence that our assumption is good to <5% for the applications described.

The argument in this detailed description assumes that when an interior electrode is charged positive, the negative charge on that interior electrode is held in place by the trapped positive charge on the previously charged electrode. This is an approximation and more accurately we can expect that most, but not all of the negative charge will be held in place. (The argument applies for negative charge voltage as well.) With the first set of 3 electrodes (1 outer and 2 inner), we see the first signs of error in our approximation. In charging the 2 inner electrodes, we raise the effective voltage of the outer electrode nearest the target conductor. This results in more trapped positive charge on the outer electrode coupling with the target conductor and less coupling with the nearest inner electrode. At the same time, the other surface of the effected inner electrode receives a full positive charge, so we have a slight net positive charge on the first inner electrode rather than the net zero charge used in our approximation. When we charge the next pair of inner electrodes, we raise the voltage of the outer electrode again and divert more trapped positive charge to couple with the target conductor. Again, less negative charge is held in place and again the net charge on this new inner electrode is slightly positive, this time slightly more so. This continues as the entire stack of electrodes is charged. With each charge sequence, we gather more and more net positive charge.

We begin by examining the loss of negative charge in the first set of 3 electrodes, outer electrode 2O1 and inner electrodes 2I1 and 2I2. We examine the loss of negative charge on 2I1 when 2I1 and 2I2 are charged.

With our initial charge sequence, we apply V_{S} to electrode 2O2 and ground electrode 2I1. With the target conductor also grounded we have positive charge induced on both surface of 2O1. Most of the charge is between 2O1 and 2I1 because C2>>C1.

V_{S}(C1+C2)=Q_{2O1}, V_{2O1}=V_{S} Charge trapped on 2O1 (eq. 60)

V_{S}C1=Q₁₀ (original charge across air gap) (eq. 61)

### And

V_{S}C2=Q₁₁ (original charge induced between 2O1 and 2I1) (eq. 62)

We trap the positive charge on 2O1 and apply V_{S} to 2I1 with 2I2 grounded. This causes the voltage potential of 2O1 to be raised above V_{S}.

(V_{2O1}−V_{S})C2+V_{2O1}C1=Q_{2O1}=V_{S}(C1+C2) (eq. 63)

### With

(V_{2O1}−V_{S})C2=negative charge held in place on 2I1 (eq. 64)

### And

V₂₀₁C1=charge now induced across air gap to target conductor (eq. 65)

We rearrange eq. 63 to solve for V_{2O1}.

$$\begin{matrix}{V}_{201} ( C 1 + C 2 ) = {V}_{S} ( 2 C 2 + C 1 ) = {V}_{S} ( C 1 + C 2 + C 2 ) \\ Or & eq . ( 66 ) \\ {V}_{201} = {V}_{S} ( 1 + \frac{C 2}{C 1 + C 2} ) & eq . ( 67 )\end{matrix}$$

### Resulting in:

$$\begin{matrix}{V}_{201} C 1 = {V}_{S} ( 1 + \frac{C 2}{C 1 + C 2} ) C 1 ( new induced charge across air gap ) \\ And \text{:} & eq . ( 68 ) \\ ( {V}_{201} - {V}_{S} ) C 2 = {V}_{S} ( \frac{C 2}{C 1 + C 2} ) C 2 ( new negative charge held in place on 2 / 1 ) & eq . ( 69 )\end{matrix}$$

### While:

V_{S}C2=(positive charge held in place on 2I1) (eq. 70)

Subtracting (eq. 69) from (eq. 70) yields the net charge on 2I1 when 2I1 is disconnected from ground and the net charge is trapped.

$$Net charge on 2 / 1 is {V}_{S} C 2 ( 1 - \frac{C 2}{C 1 + C 2} ) \qquad eq . ( 71 )$$

We will apply some expected values to see what these equations tell us. We expect C1 to be part of an air or vacuum gap typically 0.020 in. We expect C2 to be part of a high capacitance material, such as 3M with an insulation gap of 0.00043 in and ε_{R}=20.

### So:

$$\frac{0.00043}{0.03 \cdot 20} = \frac{C 1}{C 2} 0.0007166666667 \qquad eq . ( 72 )$$

And results using (eq. 71) might typically be on the order of:

$${V}_{S} C 2 ( 1 - \frac{1}{1 + 0.0007166666667} ) = {V}_{S} C 2 ( 0.0007161534234 \qquad eq . ( 73 )$$

Net charge is positive, but almost zero (0.072% net+) If this trend continues on a linear basis, we have n 0.0007161534234 (net positive charge accumulated in the stack of electrodes. For n=200, we accumulate 0.14323068468% positive charge in the stack which we will neglect. We do not expect the relationship to be linear, preliminary indications are it is a mathematical series. A more proper solution would probably involve an electrostatic simulation. We conclude the approximation in which we assume charge trapped on electrode 2O1 arranges itself according to the relationship between C1 and nC2 is conservative. This assumes no net positive charge on the interior electrodes. The additional positive charge can only help as per Gauss' Law of Charge. Our approximation looks good to <5% for an air gap of 0.030 in and n=200.

Although the invention has been described with reference to certain preferred embodiments, it will be appreciated that many other variations and modifications thereof may be devised in accordance with the principles disclosed herein. The invention, including the described embodiments and all variations and modifications thereof within the scope and spirit of the invention, is defined in the following claims.

What is claimed is:

1. A Charge-Driven Electrostatic Inductance apparatus comprising: a) a stack of multiple parallel electrode capacitors, b) a charging system, c) a target conductor, separated from said stack of capacitors by an insulation gap, d) a support structure wherein said stack of capacitors, said charging system, said target conductor and said insulation gap are located, attached and supported;
said stack of multiple parallel capacitors, wherein each said capacitor is charged, whereby the voltage across each said individual capacitors is aligned in a common direction and said stack voltage is the sum of the voltages of said individual capacitors, wherein said stack charge is trapped in place with said charging system disconnected, wherein the electrode of said charged stack furthest from said insulation gap can be electrically grounded, whereby the charge on said grounded electrode changes as said target conductor moves in said insulation gap, whereby said grounded electrode charge change is equal and opposite to the change in charge induced on said target conductor;
said charging system comprising a power source, a system of switches and a controller, wherewith said capacitors can, selectively, be charged and discharged on command, whereby said capacitors can be charged so that their individual voltages add in series;
said target conductor and said insulation gap between said stack of capacitors and said target conductor, whereby one end electrode from said stack of capacitors can be terminated to ground and the other end of said stack of capacitors can induce charge on said target conductor using electrostatic induction, whereby movement of said target conductor in said insulation gap changes said induced charge thereon, whereby equal and opposite charge is induced on said grounded electrode.

2. An apparatus according to claim 1 whereby individual electrodes in said stack of capacitors can each be connected to said voltage source or disconnected from said voltage source on command.

3. An apparatus according to claim 2 whereby individual electrodes in said stack can be connected to ground and disconnected from ground on command.

4. An apparatus according to claim 3 whereby individual electrodes can be connected to said voltage source or disconnected from said voltage source independent of being connected to said ground or disconnected from said ground on command.

5. An apparatus according to claim 4 whereby said individual electrodes in said stack can be connected to any of several voltage sources and can be disconnected from any of said voltage sources on command and whereby said voltage sources can be positive or negative.

6. A method, whereby an apparatus can charge each individual capacitor within a stack of capacitors, whereby the voltage across each said individual capacitor is in the same direction and the voltage across said stack of capacitors is the sum of the voltages on each said individual capacitor comprising: 1) a sequence of charging steps, 2) a method for using trapped charge to provide isolation for charges on the said outer electrodes of said stack of electrodes;
said sequence of charging steps comprising: 1) Connect a said first electrode of a said individual capacitor to a said voltage source and connect the second electrode of the said individual capacitor to ground, thereby charging said electrodes, 2) Trap charge on said second electrode by disconnecting said second electrode from ground and trap charge on said first electrode by disconnecting it from said voltage source. 2) Connect said voltage source to said second electrode and connect a third electrode, immediately adjacent to said second electrode, to ground, thereby charging said second and third electrodes, 3) Disconnect said third electrode from ground and disconnect said voltage source from said second electrode, leaving charge trapped on said first, second and third electrodes and with charge on said first electrode equal and opposite to charge on said third electrode, with equal and opposite charges both present on said second electrode, 4) Repeat steps 1) thru 3) until all individual capacitors are charged, whereupon positive charge is trapped on one outer electrode, whereby negative charge is trapped on the other outer electrode, whereby positive charge is trapped on one surface of and negative charge is trapped on the other surface of each internal electrodes, whereby net charge on said internal electrodes is minimal, whereby separation between positive charge on one said outer electrode and negative charge on said other outer electrode is separated by said internal electrodes and said dielectric layers with minimal net charge on each internal electrode, whereby said net charge adds to said trapped charge on said first outer electrode, whereby voltage across said stack of capacitors is equal to the sum of the voltages across each said individual capacitor;
said method for using trapped charge to provide isolation for charges on said outer electrodes of said stack of electrodes, whereby said electrodes can be charged in groups of three, whereby charge trapped on one electrode is used to hold opposite charge on second adjacent electrode while said second electrode and a third electrode, adjacent to said second electrode, are charged, thereby leaving a stack of three electrodes with opposite charges on said first and third electrodes and both positive and negative charges on the electrode surfaces of said second electrode, whereby said second electrode has minimal net charge and said first and third electrodes contain opposite charges separated by said second electrode and the dielectric layers between said first and said third electrodes, whereby said method for using trapped charge to provide isolation for charges in a stack of three electrodes can be repeated to provide charge isolation for a stack of multiple electrodes whereby the charge on one outer electrode is positive, the charge on the other outer electrode negative and said internal electrodes between contain both positive and negative charges with reduced net charge, whereby said net charge adds to said first outer electrode charge, thereby adding to said isolation between charge on said first and second outer electrodes and adding like charge to reinforce said first outer electrode charge.

7. A method according to claim 6, whereby said stack of capacitors can be discharged to ground on command.

8. A method according to claim 7, whereby a positive and negative voltage source can be used to charge said individual capacitors to double said capacitor charge density and double said stack voltage.

9. A method according to claim 8, whereby an apparatus with a stack of multiple capacitors connected to each other in groups, therein, can charge multiple electrodes in one step.

10. A method according to claim 9, whereby an apparatus with a stack of multiple capacitors, connected to each other in three groups therein, can charge said multiple capacitors in three steps.

11. An apparatus according to claim 5, wherein said internal electrodes are connected to each other in groups, wherein all electrodes in each said group are connected to a said voltage source or to ground through a common set of switches, whereby each group can be operated independent of all other groups, wherein individual internal electrodes in each said group are interleaved with said individual electrodes of two other said groups, wherein said outer electrodes are each switched to a said voltage source or a said ground, independent of each other and independent of said internal electrode groups.

12. An apparatus, according to claim 5, wherein said internal electrodes are connected to each other in three groups, whereby said apparatus can be charged in three steps.

13. A Charge-Driven Electrostatic Induction energy conversion apparatus, according to claim 12, comprising: 1) A stationary member with one or more poles, 2) A moving member with one or more poles, 3) An insulation gap in each said stationary pole, wherein each said pole can move with full range of motion and low energy loss, 4) A controller, 5) A support structure wherein said stationary member, said moving member, said insulation gaps and said controller are contained, located and supported;
a Charge-Driven Electrostatic Induction energy conversion apparatus whereby input electrical energy is converted to mechanical energy in the form of motor work output, wherein input electric energy is provided to the stationary member poles, whereby said poles selectively store and remove electric energy from said stationary member insulation gaps, whereby the moving member moves to reduce said stored electric energy therein, whereby mechanical work is produced at the output, wherein movement by said moving member is bi-directional, wherein said stationary poles can be selectively charged, whereby said moving member is constrained in place with power off, wherein said stationary poles can be discharged, whereby said moving member is free to move with power off;
a Charge-Driven Electrostatic Induction energy conversion apparatus whereby input mechanical energy is converted to electrical energy in the form of generator electrical energy output, wherein input electrical energy is provided to stationary member poles, wherein electric energy is stored in the insulation gaps of said poles, wherein said input electrical energy is turned off, wherein said stored electric energy remains in the insulation gaps, wherein input mechanical energy is provided to move said moving member, whereby said moving member movement periodically alters the energy stored in said insulation gaps therein, whereby alternating electrical energy is produced at the output;
a Charge-Driven Electrostatic Induction energy conversion apparatus whereby energy conversion is convertible, whereby input mechanical energy can be converted to output electrical energy or input electrical energy could be converted to output mechanical energy on command;
a stationary member, according to claim 12, with one or more poles, each with a Charge-Driven Electrostatic Inductance apparatus therein, an insulation gap therein, and a target conductor therein, wherein each said insulation gap is between said Charge-Driven Electrostatic Inductance apparatus and said target conductor, wherein each said insulation gap is constructed whereby said moving member can perform full range of motion with low energy loss, wherein each said Charge-Driven Electrostatic apparatus is able to independently induce or remove stored electric energy in its insulation gap, wherein each said Charge-Driven Electrostatic Inductance pole can selectively power off with or without retaining stored electric energy in its insulation gap;
a moving member with one or more poles wherein said moving member is electrically conductive, wherein each pole can move with full range of motion in its insulation gap with low energy loss, whereby stored electric energy in said insulation gap is maximally altered by movement of said moving member.

14. A Charge-Driven Electrostatic Induction motor according to claim 13, wherein input electric energy is converted to output mechanical work, wherein said moving member rotates, whereby output mechanical work is rotational.

15. A Charge-Driven Electrostatic Induction motor according to claim 14, wherein said moving member can continuously rotate in either of two opposite directions, whereby said mechanical work output can be continuous in either of two opposite angular directions, wherein said angular velocity of said moving member can be increased or decreased on command, whereby angular velocity of said mechanical work output will be increased or decreased on command.

16. A Charge-Driven Electrostatic Induction motor according to claim 13, wherein said moving member can move back and forth in rotation between two angular end positions, whereby said output mechanical work output will be back and forth rotation between said angular end positions, wherein said back and forth motion can be periodic and oscillatory and said oscillatory motion can vary in frequency and amplitude on command, whereby said output mechanical work will be oscillatory with said commanded frequency and amplitude.

17. A Charge-Driven Electrostatic Induction motor according to claim 13, wherein input electric energy is converted to output mechanical work, wherein said moving member translates back and forth between two separated end points on command, wherein linear velocity, one-way travel distance and travel midpoint can vary on command, wherein said moving member can periodically oscillate, with frequency and said travel distance amplitude variable on command, whereby said output mechanical work follows said motion of said moving member.

18. A Charge-Driven Electrostatic Induction motor according to claim 17, wherein said moving member has multiple poles, sufficient to support the travel distance between said two separated end points and wherein said stationary member has sufficient number of poles to perform a minimum back and forth motion between three said moving member poles.

19. A Charge-Driven Electrostatic Induction generator according to claim 13, wherein input mechanical power moves said moving member, wherein said stationary poles are charged with electric energy, whereby electric energy is stored in said stationary member insulation gaps therein, wherein said stored electric energy remains with electric power to said stationary member off, wherein movement of said moving member alters said stored energy, whereby alternating electric power is generated at said generator output.

20. A Charge-Driven Electrostatic Induction generator according to claim 19, wherein input mechanical power is rotational, wherein said moving member moves in rotation, whereby alternating electrical power is generated at said generator output.

21. A Charge-Driven Electrostatic Induction generator according to claim 20, wherein said rotary motion is continuous and bi-directional, wherein said rotary angular velocity and direction can be varied on command, whereby a constant angular velocity by said moving member outputs alternating electric power, whereby the frequency of said output electric power is directly proportional to the angular velocity of said moving member and is variable on command.

22. A Charge-Driven Electrostatic Induction generator according to claim 20, wherein said input rotary mechanical power is back and forth, whereby said moving member moves back and forth between angular end point limits therein, whereby alternating electric power is generated at said generator output, wherein input rotary mechanical power that is variable in angular velocity outputs alternating electric power that is variable in frequency, wherein input rotary mechanical power that is variable in angular travel outputs alternating electric power that is variable in amplitude, wherein input rotary mechanical power that is variable in its center of back and forth rotation outputs electric power with an amplitude offset, wherein said input mechanical power motion can be varied to output alternating electric power that varies in frequency, amplitude and wave crossing zero points.

23. A Charge-Driven Electrostatic Induction generator according to claim 19, wherein said input mechanical power has linear back and forth motion, whereby said moving member moves in linear back and forth motion between two limiting end points therein, whereby output alternating electric power is generated, whereby said output alternating electric power has a higher amplitude when said moving member has a larger travel range, whereby said output alternating electric power has a higher frequency when said moving member takes less time to travel from said end point to said end point, whereby said output alternating electric power has an offset depending on center of travel of said moving member therein, whereby variations in said input mechanical power movement can be used to alter said alternating electric power output.

24. A deformable Charge-Driven Electrostatic Induction generator according to claim 19, comprising 1) A deformable structural housing member with one or more said Electrostatic Induction poles, 2) A deformable moving member, with one or more said Electrostatic Induction poles, that moves relative to said structural housing member, 3) A deformable insulation gap between each said structural housing member pole and the nearest said moving member pole, 4) An apparatus for applying external mechanical energy to move said moving member with respect to said structural housing member, 5) A deformable apparatus for receiving, storing and managing electrical energy with micro-controller therein;
said deformable generator apparatus wherein said moving members move in back and forth motion, wherein said back and forth motion is in response to back and forth mechanical input, wherein said deformable structural members deform elastically and rest position is restored when said mechanical input is removed, wherein said deformable members each deform with an individual spring constant and range of motion, whereby relative motion between said moving member and said stationary member poles is achieved, whereby said alternating electric power is generated, while mechanical force is generated to satisfy said mechanical operational requirements, wherein electronic components are embedded in said deformable members so as to remain rigid while moving with said deformable members, wherein said rigid electronic components do not interfere with electrical and mechanical performance of said deformable members;
said deformable moving member whereby deformation does not interfere with electrical conductivity therein;
said deformable structural housing member whereby deformation does not interfere with electrical performance of said poles therein;
said deformable apparatus for receiving, storing and managing electrical energy, whereby said generated electrical energy is received, stored and made available to external users, whereby external electrical power can be received and controlled to recharge said stationary member poles, whereby said apparatus deforms with range of motion and spring constant consistent with system requirements of said deformable electrostatic generator, wherein said storage capacitors are deformable, wherein discrete electronic components are embedded in said deformable apparatus so as to retain their rigid structures while moving therein.

25. A Charge-Driven Electrostatic Induction sensor according to claim 13, whereby mechanical forces are sensed, wherein said moving member moves in response to external forces, whereby said insulation gap stored electric energy is altered therein, whereby said stored charge on said moving member and on the grounded outer electrode of effected said Charge-Induction poles is changed therein, whereby said change in stored charge is sensed as electric current therein, whereby back and forth movement of said moving member generates alternating electric power and information therein, whereby said generated alternating electric power and information is amplified therein, whereby said amplified electric power and information is made available for external use.

26. A Charge-Driven Electrostatic Induction sensor according to claim 25, wherein said moving member is a diaphragm that can vibrate in response to sound waves, wherein said vibration amplitude alters said stored gap electric energy sufficient to generate adequate sensed alternating electrical power, wherein said diaphragm vibrates with sufficient frequency response to sense high frequency components of said sound waves.

27. An electrostatic power and information transfer apparatus, according to claim 12, comprising: 1) A stationary transmit member, 2) A move receive member, 3) An insulation gap between said stationary transmit member and said move receive member, 4). A controller, 5). A support structure wherein said stationary transmit member, said move receive member, said insulation gap and said controller are contained, located and supported;
said electrostatic power and information transfer apparatus whereby said stationary transmit member can electrostatically induce alternating electric charge in said move receive member and store electric energy in said insulation gap, whereby said induced alternating charge is processed to store electrical energy in said move receive member, whereby said electrical energy stored in said move receive member can be selectively applied by said move receive member to perform useful work, whereby said electrostatic power transfer and said electric energy stored in said insulation gap are independent of said move receive member position or motion, whereby said position change or motion does not cause energy loss and information and energy transfers are efficient;
said stationary transmit member whereby a Charge-Driven Electrostatic Induction apparatus therein, can selectively induce electric charge in said move receive member and store electric energy in said insulation gap, whereby said induced charge and said stored electric energy therein, can be fixed, alternating or absent on command;
said move receive member whereby said alternating induced charge can be stored as electric energy, whereby said stored electric energy can be selectively applied to perform useful work in a form of choice, including direct or alternating current, wherein an electronic system of capacitors, computer controlled switches, discrete electronic components and a microcontroller, receive, store and apply said transferred electric power and information, whereby transferred electric power and transferred information can be applied in said receive member;
said support structure wherein said move receive member can move and change position with respect to said stationary transmit member, whereby movement between said move receive member and said support structure is performed and constrained by low friction means, whereby said movement or position change does not affect electric energy stored in said insulation gap between said move receive member and said stationary member, whereby said move receive member can perform useful work by means of said electric energy stored therein;
said insulation gap whereby said move member can move and change position with respect to said stationary member without contact and low friction between said move member and said stationary member, whereby said movement and position change do not affect energy storage in said insulation gap, whereby said electrostatic power and information transfer is more accurate and efficient.

28. A stationary transmit member according to claim 27 with one or more poles, each with a Charge-Driven Electrostatic Inductance apparatus therein, an insulation gap therein and a target conductor therein, wherein each said insulation gap is between said Charge-Driven Electrostatic Inductance apparatus and said target conductor, wherein each said insulation gap is constructed whereby said moving member can perform full range of motion with minimum change in said gap stored electric energy, wherein each said Charge-Driven Electrostatic apparatus is able to independently induce or remove stored electric energy in its insulation gap, wherein each said Charge-Driven Electrostatic Inductance pole can selectively power off with or without retaining stored electric energy in its insulation gap.

29. A move receive member apparatus according to claim 27 with an electric energy storage and management system therein comprising: 1) An electrostatic induction electrode, 2) An electric energy storage capacitor, 3) A system of computer controlled switches, 4) A controller, whereby electric charge is first induced on said electrostatic induction electrode, then transferred to said electric energy storage capacitor, whereby said cycle of charge induction and charge transfer is continued until sufficient electric energy is stored in said electric energy storage capacitor, whereby said stored electric energy can be selectively expended do useful work, whereby said cycle of energy storage and said stored energy expenditure can continue on an extended basis.

30. A system of computer controlled switches according to claim 29 wherein a first switch connects said electrostatic induction electrode to electrical ground, a second switch connects said induction electrode to a first electrode of said energy storage capacitor, a third switch connects said first electrode to electrical ground, a fourth switch connects a second electrode of said energy storage capacitor to electrical ground, a fifth switch connects said first electrode to an output load input terminal and a sixth switch connects said second electrode to said output load input terminal.

31. A method for charging said electric energy storage capacitor and expending said electric energy stored therein, using switches according to claim 30, comprising steps: 1) charge induction, 2) charge transfer, 3) energy storage, 4) energy expending, whereby said energy expending is with electric current of discretionary polarity.

32. A method for performing said charge induction step, according to claim 31, wherein said first switch is closed, said second switch is open, said third switch is open, said fourth switch is closed, said fifth switch is open and said sixth switch is open during said charge induction period.

33. A method for performing said charge transfer step, according to claim 31, wherein said first switch is open, said second switch is closed, said third switch is open, said fourth switch is closed, said fifth switch is open and said sixth switch is open.

34. A method for performing said energy storage step, according to claim 31, whereby steps 32 and 33 are performed multiple times, whereby additional electric energy is added to said storage capacitor.

35. A method for performing said energy expending step, according to claim 31, whereby electric current of a first polarity is supplied to said load from said first electrode, wherein said sixth switch is open, said fifth switch is closed, said fourth switch is closed, said third switch is open, said second switch is open and said first switch is discretionary.

36. A method for performing continuous energy expending according to claim 31 whereby said load is preceded by a switched capacitor system whereby energy charging and energy expending can be performed simultaneously.

37. An apparatus according to claim 19, wherein said alternating, induced charge in said stationary member is terminated in a Driven Ground [9] circuit between electrical ground and said output electrical power is taken from the op-amp output of said Driven Ground circuit, whereby electrical power required to maintain said Driven Ground apparatus is much less than the electrical energy generated by said Charge-Driven Electrostatic Induction generator, whereby a net increase in available electric power is generated.

38. An apparatus according to claim 37, wherein the feedback loop in said Driven Ground [9] circuit is open, whereby said Driven Ground op-amp output goes rail to rail in response to alternating induced charge in said stationary member, whereby said generator output is a series of positive and negative pulses.

39. An apparatus according to claim 25, wherein said alternating, induced charge in said stationary member is terminated in a Driven Ground [9] circuit between electrical ground and electrical ground, wherein said feedback loop provides high gain alternating electrical power and information, wherein said generated, amplified output is made available for external application.

40. An apparatus according to claim 19, whereby a Charge-Driven Electrostatic generator can generate and store electrical power using mechanical power only, until sufficient electrical energy is stored to activate and apply electrical power to the conversion process comprising: 1) A Charge-Driven Electrostatic generator with a said grounded outer electrode, 2) A Charge Pump and storage system, 3) An electric power management system, 4) a controller;
said Charge-Driven Electrostatic generator system wherein electric energy is initially stored in said one or more insulation gaps and remains with electrical power off, wherein said input back and forth mechanical energy causes time-varying charge changes on said grounded outer electrode, wherein said time-varying charge changes produce alternating current, whereby electrical energy is stored in a capacitor therein, wherein said system can be activated when sufficient energy is stored in said capacitor, whereby said system performance can be improved, wherein said generator system returns to passive sleep operation when said stored electrical energy is insufficient for active operation;
said passive sleep mode charge pump and storage system wherein said grounded outer electrode is connected to electrical ground through two parallel paths, wherein a first path is from said outer electrode to ground through a diode, wherein a second path is from said outer electrode to ground through a diode followed by a storage capacitor, wherein said diodes allow electric current flow in a single direction, wherein said direction of current flow is from ground through a said diode to said outer electrode and from said outer electrode through a said diode to said storage capacitor, wherein said current flows from ground through a first diode to said outer electrode when said insulation gap stored energy is decreased, wherein said current flows from said outer electrode through a said second diode to said storage capacitor when said insulation gap stored energy is increased, whereby time variant motion of said moving member causes time variant stored energy in said insulation gap, whereby charge is pumped into said storage capacitor with each movement cycle of said moving member, whereby said charge pumping and storage is performed without external electric power;
wherein said Charge-Driven Electrostatic generator can be initially charged with opposite charge on said grounded outer electrode, whereby said charge pump current flows from electric ground through said storage capacitor through said second diode to said outer conductor and from said outer conductor through said first diode to ground, whereby charge type in said storage capacitor has been changed and direction of said charge pump current has been changed;
said charge pump and storage system wherein computer controlled switches can be activated when electric energy in said stored capacitor is sufficient, whereby said one-way current flow can be maintained by synchronizing switch actions with movement of said moving member, whereby the diode forward voltage drop penalty can be avoided.

41. A deformable Charge-Driven Electrostatic Induction generator according to claim 24 whereby said electrostatic generator can generate and store electrical power using mechanical power only, until sufficient electrical energy is stored to activate and apply electrical power to the conversion process.

42. A deformable Charge-Driven Electrostatic Induction generator whereby electrical energy is generated and stored according to claim 40.
